(19) United States
(12) Patent Application Publication
(10) Pub. No.: US 2014/0340931 A1
(43) Pub. Date: Nov. 20, 2014

(54) LIGHT INTENSITY DISTRIBUTION CONVERSION ELEMENT, PLANAR LIGHT SOURCE DEVICE, AND LIQUID CRYSTAL DISPLAY DEVICE

(71) Applicants: Rena Nishitani, Tokyo (JP); Nami Nakano, Tokyo (JP); Shuichi Kagawa, Tokyo (JP); Muneharu Kuwata, Tokyo (JP); Kuniko Kojima, Tokyo (JP)

(72) Inventors: Rena Nishitani, Tokyo (JP); Nami Nakano, Tokyo (JP); Shuichi Kagawa, Tokyo (JP); Muneharu Kuwata, Tokyo (JP); Kuniko Kojima, Tokyo (JP)

(73) Assignee: Mitsubishi Electric Corporation, Tokyo (JP)

(21) Appl. No.: 14/344,875

(22) PCT Filed: Sep. 10, 2012
(86) PCT No.: PCT/JP2012/005701

§ 371 Date: Apr. 16, 2014

(30) Foreign Application Priority Data
Sep. 15, 2011 (JP) 2011-201878

(51) Int. Cl. F21V 8/00; G02B 27/09; F21K 99/00

(52) U.S. Cl. CPC G02B 6/0031; F21K 9/52; G02B 27/0927; G02B 6/003; G02B 6/0025; G02B 6/0028; G02B 6/0068
USPC 362/609; 362/343

(57) ABSTRACT

A light intensity distribution conversion element has a light incident surface, a light emission surface, and total reflection surfaces. Light having directivity enters the light incident surface. The light emission surface has a curved surface portion of a concave shape with respect to an emitting direction of the light, for broadening an angular intensity distribution of the light. The total reflection surfaces are near or are adjacent to the curved surface portion, are slanted against the emitting direction of the light, and totally reflect the light. The light reflected by the total reflection surfaces is emitted from the curved surface portion.

### TECHNICAL FIELD

The present invention relates to a light intensity distribution conversion element, a planar light source device, and a liquid crystal display device, in which a laser is employed as a light source and planar light having a uniform intensity distribution is generated from point-like laser light.

### BACKGROUND ART

A liquid crystal display element equipped in a liquid crystal display device is not self-luminous. Therefore, a liquid crystal display device has a planar light source device at a rear surface of a liquid crystal display element, serving as a light source for illuminating the liquid crystal display element. As a light source for the planar light source device, cold cathode fluorescent lamps have been mainly used traditionally. The cold cathode fluorescent lamp (hereinafter, referred to as CCFL) is a lamp in which a fluorescent material is coated on an inside wall of a glass tube so as to acquire white light. However, as the performance of light emitting diode (hereinafter, referred to as LED) has been tremendously improved in recent years, demands for a planar light source device employing LEDs as a light source have been rapidly increased.

However, color purity of light emitted from the CCFLs and LEDs is low. Thus, it has been a problem that the color reproduction range is narrow in a liquid crystal display device employing such light sources. Here, low color purity means that the light has poor monochromaticity because it contains plural wavelengths.

Recently, for the purpose of providing a liquid crystal display device having a wide color reproduction range, there has been proposed to employ a laser which has high color purity as a light source thereof. Because light emitted from a laser has excellent monochromaticity, vivid images can be provided. Here, a monochrome means a color having a narrow wavelength width, i.e. a single color without any color mixture. Monochromatic light means a single color light having a narrow wavelength width.

On the other hand, however, when a laser in which light having high directivity is emitted from a point light source is employed as a light source of a planar light source device, it is very difficult to obtain planar light having a spatial light intensity distribution with high uniformity.

A planar light emitting device and an image display device described in Patent Document 1 has an optical system configured with a plurality of optical elements. Light emitted from a laser is arranged, through the optical system, to have a light intensity distribution of a desired shape. Thus, the light emitted from the laser is emitted from the planar light emitting device as planar light having high uniformity.

### PRIOR ART DOCUMENT

### Patent Document

Patent Document 1; Japanese Unexamined Patent Application Publication No. 2009-181753

### SUMMARY OF THE INVENTION

### Problem that the Invention is to Solve

In a planar light emitting device and an image display device described in Patent Document 1, a large-scale optical system is necessary in which a plurality of elements for arranging the shape of a light intensity distribution of laser light are disposed. Recently, downsizing and a simplified configuration are demanded for liquid crystal display devices. It is difficult to achieve the downsizing and simplified configuration of a liquid crystal display device if the configuration described in Patent Document 1 is employed.

The present invention is made considering the above described problems, and its purpose is to provide a light intensity distribution conversion element having a simplified configuration. Another purpose thereof is, by using the light intensity distribution conversion element, to provide a planar light source device and a liquid crystal display device that have simplified configurations and that emit planar light having a spatial light intensity distribution with high uniformity.

### Means for Solving the Problem

A light intensity distribution conversion element according to the present invention is comprised of a first light incident surface which first light having directivity enters; a first light emission surface, having a curved surface portion of a concave shape with respect to an emitting direction of the first light, for broadening an angular intensity distribution of the first light; and a total reflection surface that is near or is adjacent to the curved surface portion, that is slanted against the emitting direction of the first light, and that totally reflects the first light, wherein the first light reflected by the total reflection surface is emitted from the curved surface portion.

### Advantageous Effects of the Invention

The present invention enables to provide, with a simplified configuration, planar light having a wide color reproduction range and an in-plane brightness distribution with excellent uniformity.

### BRIEF DESCRIPTION OF DRAWINGS

FIG. 1 is a configuration diagram schematically showing a configuration of a liquid crystal display device according to Embodiment 1 of the present invention.

FIG. 2 is a configuration diagram schematically showing a configuration of a planar light source device according to Embodiment 1 of the present invention.

FIG. 3 is a block diagram showing an operation method for a liquid crystal display element and a light source according to Embodiment 1 of the present invention.

FIG. 4 is a block diagram showing an operation method for the liquid crystal display element and light sources according to Embodiment 1 of the present invention.

FIG. 5 is a configuration diagram schematically showing a light diffusion structure according to Embodiment 1 of the present invention.

FIG. 6 is a diagram schematically showing light behavior in the light diffusion structure according to Embodiment 1 of the present invention.

FIG. 7 is another diagram schematically showing light behavior in the light diffusion structure according to Embodiment 1 of the present invention.

FIG. 8 is another diagram schematically showing light behavior in the light diffusion structure according to Embodiment 1 of the present invention.

FIG. 9 is a characteristic diagram showing an angular intensity distribution, in a Z-X plane, of emitted light from the light diffusion structure according to Embodiment 1 of the present invention.

FIG. 10 is another diagram schematically showing light behavior in the light diffusion structure according to Embodiment 1 of the present invention.

FIG. 11 is another configuration diagram schematically showing light diffusion structures according to Embodiment 1 of the present invention.

FIG. 12 is a configuration diagram schematically showing a configuration of a liquid crystal display device according to Embodiment 2 of the present invention.

FIG. 13 is a configuration diagram schematically showing a configuration of a planar light source device according to Embodiment 2 of the present invention.

FIG. 14 is another configuration diagram schematically showing a configuration of a liquid crystal display device according to Embodiment 2 of the present invention.

FIG. 15 is another configuration diagram schematically showing a configuration of a liquid crystal display device according to Embodiment 2 of the present invention.

FIG. 16 is a configuration diagram schematically showing a configuration of a liquid crystal display device according to Embodiment 3 of the present invention.

FIG. 17 is a configuration diagram schematically showing a configuration of a planar light source device according to Embodiment 3 of the present invention.

FIG. 18 is a block diagram showing an operation method for a liquid crystal display element and light sources according to Embodiment 3 of the present invention.

FIG. 19 is a configuration diagram schematically showing a configuration of a liquid crystal display device according to Embodiment 4 of the present invention.

FIG. 20 is a configuration diagram schematically showing a configuration of a planar light source device according to Embodiment 4 of the present invention.

### MODE FOR CARRYING OUT THE INVENTION

Hereinafter, embodiments of a light intensity distribution conversion element, a planar light source device, and a liquid crystal display device according to the present invention will be described in detail based on the drawings. Note that the present invention should not be limited by the embodiments described below.

### Embodiment 1

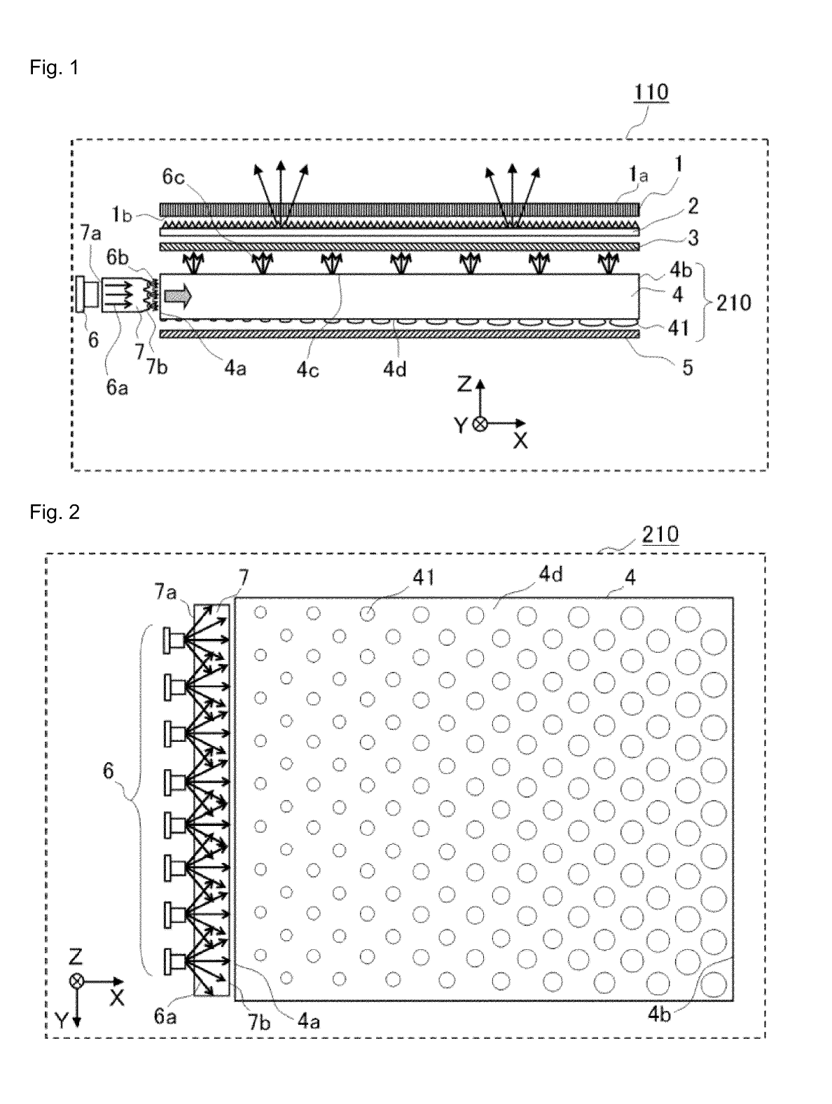

FIG. 1 is a diagram schematically showing a configuration of a liquid crystal display device 110 which is a transmission type display device according to Embodiment 1 of the present invention. In order to facilitate the explanation of FIG. 1, the short side direction of a liquid crystal optical element 1 is set to be the Y axis direction, the long side direction thereof is set to be the X axis direction, the direction normal to the X-Y plane is set to be the Z axis direction, and the display surface 1a side of the liquid crystal display element 1 is set to be the +Z axis direction. The upper direction of the liquid crystal display device is set to be the +Y axis direction, and the light emitting direction of a first light source 6 described later is set to be the +X axis direction. In the following drawings, the left hand side of the liquid crystal display device when viewed from its front side is the +X axis direction.

As shown in FIG. 1, the liquid crystal display device 110 has the liquid crystal display element 1 of the transmission type and a planar light source device 210. The liquid crystal display device 110 may have an optical sheet 2, an optical sheet 3, and a light reflection sheet 5. These constituent elements 1, 2, 3, 210, and 5 are arranged in the Z axis direction. The liquid crystal display element 1 has the display surface 1a disposed parallel to the X-Y plane. The X-Y plane is a plane containing the X axis and Y axis which are perpendicular to the Z axis. The X axis and Y axis are perpendicular to each other. The optical sheet 2 is a first optical sheet, and the optical sheet 3 is a second optical sheet.

The planar light source device 210 emits illumination light 6c toward a rear surface 1b of the liquid crystal display element 1 (toward the +Z axis direction in FIG. 1). The illumination light 6c is planar light having a uniform light intensity distribution in the X-Y plane in FIG. 1.

The illumination light 6c transmits through the second optical sheet 3 and the first optical sheet 2, and is projected to the rear surface 1b of the liquid crystal display element 1. The first optical sheet 2 has a function in which the illumination light 6c emitted from the planar light source device 210 is directed to the normal direction of a screen of the liquid crystal display device 110. The second optical sheet 3 reduces an optical influence caused by minute unevenness of the illumination light, etc.

The light reflection sheet 5 is disposed immediately below (−Z axis direction) the planar light source device 210. Light emitted from the planar light source device 210 in its rear surface side (−Z axis direction) is reflected by the light reflection sheet 5 and is utilized as the illumination light to be projected to the rear surface 1b of the liquid crystal display element 1. A light reflection sheet of a resin-based material such as polyethylene terephthalate, for example, may be employed as the light reflection sheet 5. A light reflection sheet of a substrate whose front surface is deposited by a metal may be also employed as the light reflection sheet 5.

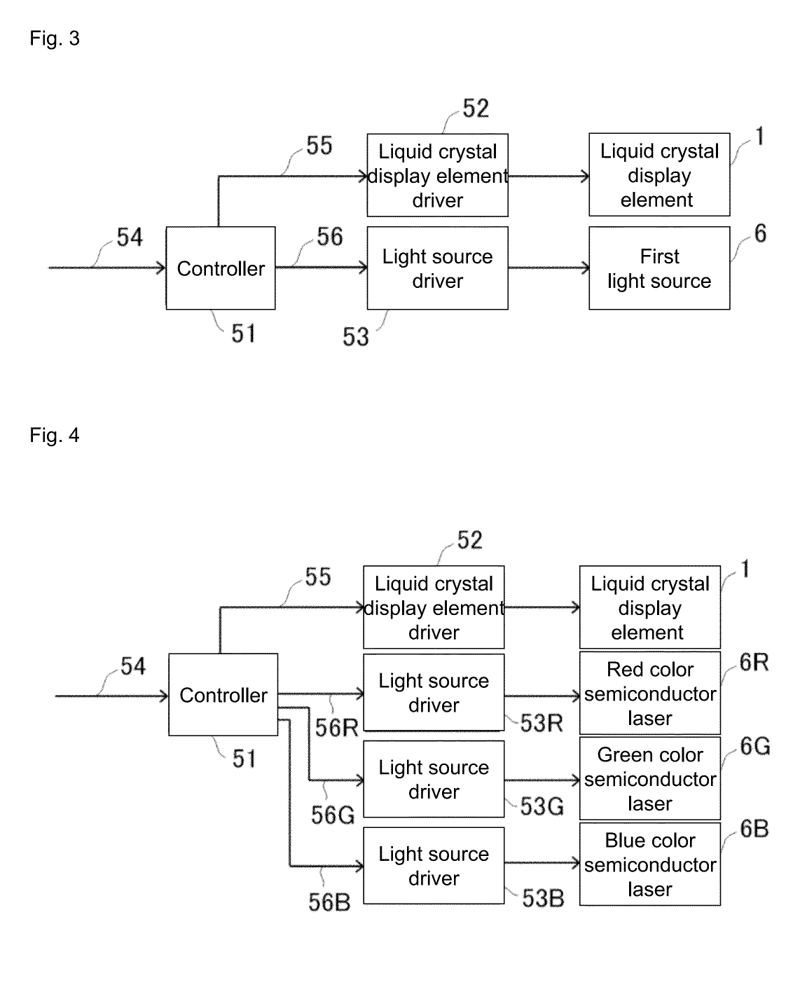

The liquid crystal display element 1 has a liquid crystal layer which is disposed parallel to the X-Y plane normal to the Z axis direction. The display surface 1a of the liquid crystal display element 1 has a rectangular shape. The X axis direction and Y axis direction shown in FIG. 1 each are the directions along the two sides of the display surface 1a, which are perpendicular to each other. As shown in FIG. 3, a liquid crystal display element driver 52 changes light transmittance of the liquid crystal layer on a pixel-by-pixel basis, in response to a control signal (liquid crystal display element control signal 55) supplied from a controller 51. Each of the pixels is configured with three sub-pixels. The three sub-pixels each have a color filter which transmits red color light only, a color filter which transmits green color light only, and a color filter which transmits blue color light only. The liquid crystal display element driver 52 generates color images by controlling the transmittance of each sub-pixel. In this way, the liquid crystal display element 1 spatially modulates the illumination light 6c emitted from the planar light source device 210 so as to generate image light. Thus, the liquid crystal display element 1 can emit the image light through the display surface 1a. Here, image light means light containing image information.

The planar light source device 210 has the light source 6, a light intensity distribution conversion element 7, and a light guide plate 4. Here, the light source 6 is the first light source. FIG. 2 is a configuration diagram showing the planar light source device 210 from the −Z axis direction.

A plurality of laser elements are arranged in the one-dimensional direction (Y axis direction) in the light source 6. Each laser element contains a semiconductor laser for emitting single color light of red color, green color, or blue color. In the light source 6 in Embodiment 1, these laser elements are regularly arranged in the Y axis direction. The wavelength of light emitted from the red color semiconductor laser is 640 nm. The wavelength of light emitted from the green color semiconductor laser is 530 nm. The wavelength of light emitted from the blue color semiconductor laser is 450 nm. White color light is generated by mixing light of these three colors. Note that the wavelength of light emitted from each of the semiconductor lasers is not limited to the above-described one, but is optimized in accordance with a desired color reproduction range. Also, the number of colors of light is not limited to three, but is optimized in accordance with a desired color reproduction range.

Light 6a emitted from the light source 6 enters the light intensity distribution conversion element 7 through a light incident surface 7a, which is a first light incident surface. While transmitting through the light intensity distribution conversion element 7, the light 6a becomes white color light having a uniform spatial light intensity distribution in the Y axis direction. Also, the light intensity distribution conversion element 7 broadens the angular intensity distribution of the light 6a in the Z-X plane. The light 6a is emitted toward an incident surface 4a of the light guide plate 4 from the light intensity distribution conversion element 7 through a light emission surface 7b thereof. The light emission surface 7b is a first light emission surface. Detailed configuration and function of the light intensity distribution conversion element will be shown later. The incident surface 4a of the light guide plate 4 is disposed to face the light emission surface 7b. In addition, the incident surface 4a of the light guide plate 4 is disposed so that the longitudinal direction thereof will be parallel to the Y axis direction.

The light guide plate 4 is made of a transparent material and is a plate-like member. For example, an acryl resin (PMMA) or the like may be employed as the transparent material. The light guide plate 4 may be a plate-like member having a thickness of 3 mm, for example.

The light guide plate 4 has light diffusion elements 41 on a rear surface 4d thereof (surface of −Z axis side). The light diffusion element 41 has a function of converting linear light, which enters the light guide plate 4 through the light incident surface 4a, into light having a planar light intensity distribution. The linear light has a uniform light intensity distribution in the one-dimensional direction (Y axis direction). The light diffusion element 41 has a function of emitting the light having the planar light intensity distribution toward the liquid crystal display element 1. Here, “plane” in the word “planar” means a plane parallel to the X-Y plane.

For example, the light diffusion element 41 has a convex lens shape shown in FIGS. 1 and 2. The light diffusion elements 41 are disposed on the rear surface 4d. Such a convex lens shape may be replaced with a concave shape. The light diffusion element 41 may have a configuration in which a dot-like white color ink is coated, for example. Here, the size of convex shape, the size of concave shape, and the size of dot-like white color ink are small in the vicinity of the light incident surface 4a, and become larger as coming close to a surface 4b located at the opposite side of the light incident surface. Or, the density of convex shape optical elements having the same size, the density of concave shape optical elements having the same size, and the density of dot-like white color inks having the same size are low in the vicinity of the light incident surface 4a, and become higher as coming close to the surface 4b located at the opposite side of the light incident surface. In these ways, the in-plane light intensity distribution of the illumination light 6c in the X-Y plane becomes uniform.

FIG. 3 is a block diagram showing an operation method for the liquid crystal display element 1 and the light source 6. The liquid crystal display element driver 52 drives the liquid crystal display element 1 based on the liquid crystal display element control signal 55 from the controller 51. A light source driver 53 drives the light source 6 serving as the first light source based on a light source control signal 56 from the controller 51. The controller 51 controls the liquid crystal display element driver 52 and the light source driver 53.

The controller 51 performs image processing on an image signal 54 supplied from a signal source (not shown) so as to generate the control signals (liquid crystal display element control signal 55 and light source control signal 56). The controller 51 supplies the control signals 55 and 56 to the liquid crystal display element driver 52 and the light source driver 53. The light source driver 53 drives the light source 6 based on the light source control signal 56 from the controller 51 and causes the light source 6 to emit light.

For example, as shown in FIG. 4, the planar light source device 210 has light source drivers 53R, 53G, and 53B each corresponding to a red color semiconductor laser 6R, a green color semiconductor laser 6G, and a blue color semiconductor laser 6B in the light source 6. In this way, a configuration may be employed in which the controller 51 controls the light source drivers 53R, 53G, and 53B separately. The light source drivers 53R, 53G, and 53B each drive the semiconductor lasers 6R, 6G, and 6B based on light source control signals 56R, 56G, and 56B from the controller 51. Thus, a balance between light intensity levels of light 6Ra, 6Ga, and 6Ba each emitted from the semiconductor lasers 6R, 6G, and 6B can be adjusted. Therefore, the controller 51 can adjust each luminescence amount of the light sources 6R, 6G, and 6B in response to the light intensity levels of the respective colors necessary for the image signals 54. As a result, it is possible to achieve a reduction in power consumption of the planar light source device 210.

Next, a structure and function of the light intensity distribution conversion element 7 will be shown.

In the planar light source device 210 in Embodiment 1, a method of what is called a side light method is employed. In the side light method, a light source and a light guide plate are provided. Light emitted from the light source enters the light guide plate through its end surface, and is emitted as planar light. Linear light entering the light guide plate through its end surface is converted into planar light by light diffusion elements disposed on the front surface (or rear surface) of the light guide plate. The planar light is emitted from the light guide plate through its front surface. In Embodiment 1, the light 6a emitted from the light source 6 enters the light guide plate 4 through the light incident surface 4a, which is a second light incident surface. In Embodiment 1, the illumination light 6c is emitted from the light guide plate 4 through its front surface 4c toward the liquid crystal display element 1. The front surface 4c is a second light emission surface.

In the side light method, in order to make illumination light, which is emitted from the planar light source device, to have a uniform spatial light intensity distribution, the following two conditions should be satisfied. The first condition is that the linear light entering the light guide plate has a uniform spatial light intensity distribution. The second condition is that a divergence angle of light in the light guide plate thickness direction is a wide angle. The wide-angle divergence means that the divergence angle is wide.

The uniform spatial light intensity distribution of the linear light entering the light guide plate means that the light which enters the light guide plate through its light incident surface has equal light intensity at any spatial position on the surface (light incident surface of light guide plate).

The wide divergence angle, in the light guide plate thickness direction, of the linear light which enters the light guide plate means that the divergence angle of the light which enters the light guide plate through its light incident surface in the light guide plate thickness direction is wide. That is, in Embodiment 1, it means that the divergence angle in the Z-X plane in FIG. 1 is wide.

The light source 6 in Embodiment 1 is configured with the laser elements each of which is a point light source and which has high directivity. Here, the point light source means a light source whose luminescent area is small relative to the area of the light incident surface 4a of the light guide plate 4. Therefore, if the light emitted from the light source 6 directly enters the light guide plate 4, unevenness of the spatial light intensity distribution, within the X-Y plane, arises in the illumination light 6c emitted from the planar light source device 210. Here, the unevenness of the spatial light intensity distribution means a state in which light intensity has different levels at different spatial positions in the same plane.

In the planar light source device in Embodiment 1, the light 6a emitted from the light source 6 which is configured with the laser elements is converted, using the light intensity distribution conversion element 7, into light having a light intensity distribution which satisfies the first condition and the second condition described above.

The laser elements disposed in the light source 6 are multi-mode semiconductor lasers. Because of the structure thereof, a divergence angle value in the direction parallel to an active layer is different from that in the direction perpendicular to the active layer in the multi-mode semiconductor laser. For example, in all the laser elements in Embodiment 1, a full angle at half maximum of the divergence angle in a larger spread angle direction (hereinafter, referred to as fast axis direction) is 40 degrees. On the other hand, a full angle at half maximum of the divergence angle in a smaller spread angle direction (hereinafter, referred to as slow axis direction) is 3 degrees. In all the laser elements disposed in the light source 6 in Embodiment 1, it is assumed that the fast axis direction thereof is parallel to the laser element arranging direction (Y axis direction in FIG. 1) and the slow axis direction thereof is parallel to the light guide plate thickness direction (Z axis direction in FIG. 1). Note that the full angle at half maximum means an angle defined by the following formula; absolute value of (angle where light intensity is maximum—angle where light intensity is half the maximum)×2.

The light intensity distribution conversion element 7 is made of a transparent material and is a plate-like member. For example, an acryl resin (PMMA) or the like may be employed as the transparent material. The light intensity distribution conversion element 7 may be a plate-like member having a thickness of 2 mm, for example. The length of the light intensity distribution conversion element 7 in its long side direction (Y axis direction in FIG. 1) is set to be equal to or shorter than the length of the light incident surface 4a of the light guide plate 4 in the Y axis direction in FIG. 1.

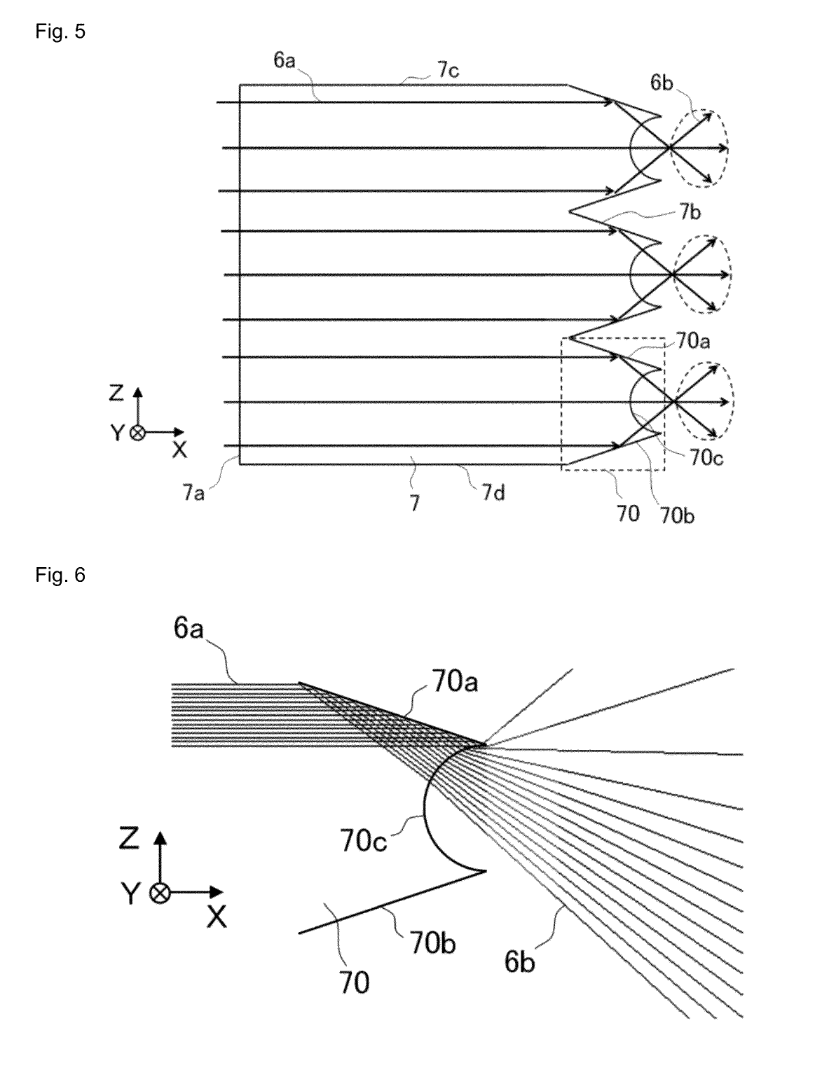

As shown in FIG. 5, the light incident surface 7a of the light intensity distribution conversion element 7 is a surface substantially parallel to the Y-Z plane in FIG. 5. The light incident surface 7a is disposed to face the light source 6. The light emission surface 7b of the light intensity distribution conversion element 7 is located at a position opposite to the light incident surface 7a. The light emission surface 7b is not a flat surface like the light incident surface 7a, but has a light diffusion structure 70. The light diffusion structure 70 has two slants 70a, 70b and a cylindrical surface 70c.

The light intensity distribution conversion element 7 has a plurality of light diffusion structures 70 on the light emission surface 7b. The light diffusion structure 70 is a first light diffusion structure. The plurality of light diffusion structures 70 are arranged with a constant interval in the thickness direction (Z axis direction in FIG. 1) of the light guide plate 4. The light diffusion structure 70 has a structure similar to that shown in FIG. 5, at a cross section parallel to the Z-X plane of the light intensity distribution conversion element 7. Therefore, the light 6a which enters the light intensity distribution conversion element 7 is subjected to a light refraction effect shown in FIGS. 5 through 8 at a plane parallel to the Z-X plane. The light diffusion structure 70 having the cross-sectional shape shown in FIG. 5 extends in the Y axis direction on the light emission surface 7b of the light intensity distribution conversion element 7. That is, when the light diffusion structure 70 is cut along the X-Y plane, the cross-sectional shape of the light emission surface 7b is a line parallel to the Y axis.

As shown in FIG. 5, the light diffusion structure 70 has the two slants 70a, 70b and the cylindrical surface 70c. The cylindrical surface 70c is disposed between the slant 70a and the slant 70b. The cylindrical surface 70c has a curvature only in the Z-X plane. The light diffusion structure 70 in Embodiment 1 has a shape, in the Z-X plane, similar to a trapezoid. The upper bottom of the trapezoid (+X axis direction side in FIG. 5) is assumed to be 0.33 mm and the lower bottom thereof (−X axis direction side in FIG. 5) is assumed to be 0.66 mm. The height of the trapezoid is 0.50 mm. The light diffusion structure 70 has a shape in which an arc of a perfect circle shape having a radius of 0.165 mm is formed at the upper bottom center of the trapezoid and the upper bottom portion is made to have a concave shape along the arc. The concave shape is the cylindrical surface 70c. That is, the light diffusion structure 70 has a concave lens shape. A side connecting the upper bottom and the lower bottom of the trapezoid is the slant 70a, and the other side is the slant 70b. Three rows of light diffusion structure 70 are arranged in the Z axis direction with an interval of 0.66 mm. That is, the slants 70a and 70b are slanted against the emitting direction of the light 6a. A distance between the slant 70a and the slant 70b increases as moving from their edges adjacent to the cylindrical surface 70c (edges at +X axis direction side) toward the other edges thereof (edges at −X axis direction side). The other edges of the slants 70a and 70b (edges at −X axis direction side) are disposed at the incident side of the light 6a (−X axis direction side) with respect to the cylindrical surface 70c.

The cylindrical surface 70c is a surface having a curvature in one direction while having no curvature in the direction perpendicular thereto. That is, the cylindrical surface 70c is a surface having a refractive power in the one direction so as to converge or diverge light while having no refractive power in the direction perpendicular thereto. The cylindrical surface 70c is a surface having a curvature in the Z axis direction while having no curvature in the Y axis direction. That is, if the Z-X plane is assumed to be a reference plane, the cylindrical surface 70c is formed by a part of a cylindrical surface shape perpendicular to a curve on the reference plane (Z-X plane). In other words, the cylindrical surface 70c has a cylindrical surface shape having an opening in the direction perpendicular to its generating line. A cylindrical surface is a curved surface corresponding to a side surface of a cylinder. That is, the cylindrical surface is a curved surface generated when a line perpendicular to a plane moves along a curve on the plane while keeping its direction constant. The cylindrical surface 70c is not a closed curve made by the above-described curve on the plane (reference plane). Thus, the cylindrical surface 70c has a cylindrical surface shape having an opening where generating lines in some region are missing. Note that a curve on the reference plane is not limited to an arc. The above-described perpendicular line is called as a generating line. The generating line direction of the cylindrical surface 70c is the Y axis direction. The Z axis direction is a direction of a line perpendicular to the direction of the generating lines from among lines connecting the two generating lines located at the edges of the cylindrical surface shape. That is, the Z axis direction is the direction of the line perpendicular to the two generating lines from among the lines connecting the two generating lines located at the edges of the cylindrical surface shape.

The slants 70a and 70b are surfaces adjacent to the edges, of the cylindrical surface 70c, located in the direction where the curvature is provided (Z axis direction). In FIG. 5, the slants 70a and 70b are surfaces perpendicular to the reference plane (Z-X plane). Note that, while the slants 70a and 70b are shown as flat surfaces in FIGS. 5 through 8, they may be curved surfaces because the slants 70a and 70b only need to be total reflection surfaces which totally reflect the light 6a. The light guide plate 4 is disposed perpendicular to the Z axis direction. The slow axis direction of the light 6a is parallel to the Z axis direction. The slow axis direction is a direction that has a smaller divergence angle. In FIGS. 6 through 8, behavior of the light 6a is explained on a configuration in which the cylindrical surface 70c is disposed between the slant 70a and the slant 70b. However, either one of the slant 70a or the slant 70b from among the slants 70a, 70b may only be employed. Even if either one of the slant 70a or the slant 70b from among the slants 70a, 70b is only employed, a certain amount of advantageous effect can be obtained.

Next, behavior of the light 6a, which is emitted from the light source 6, in the light intensity distribution conversion element 7 in the X-Y plane and in the Z-X plane will be explained separately.

In the X-Y plane, it is requested to equalize the spatial light intensity distribution in the Y axis direction. The light 6a emitted from each of the laser elements has the divergence angle of 40 degrees represented as the full angle at half maximum. That is, the light 6a has a relatively large divergence angle in the X-Y plane. Therefore, as shown in FIG. 2, light 6a emitted from each of the laser elements spatially overlaps with light 6a emitted from other laser elements adjacent thereto while propagating through the light intensity distribution conversion element 7. Thus, the spatial light intensity distribution, in the Y axis direction, of the light 6a at the light emission surface 7b becomes uniform.

The angular intensity distribution of light emitted from each of the laser elements has a substantially Gaussian shape where the intensity is high at the center and decreases drastically as moving away from the center. Thus, the spatial intensity distribution, in the Y axis direction, of light from each of the laser elements when arriving at the light emission surface 7b has the Gaussian shape. Therefore, in order to obtain the light 6a whose spatial intensity distribution uniformity at the light emission surface 7b is high, it is necessary to set the distance (length in Y axis direction) between the adjacent laser elements to be no more than a certain value or to set the distance (length in X axis direction) between the light incident surface 7a and the light emission surface 7b to be no less than a certain value. That is, it is necessary that a portion of light 6a, whose light intensity is no less than half the maximum value in its light intensity distribution, overlaps with a portion of other light 6a adjacent thereto, whose light intensity is no less than half the maximum value in its light intensity distribution, at the position of the light emission surface 7b. It is desirable that the number of the laser elements is set or the length, in the X axis direction, of the light intensity distribution conversion element 7 is set, so as to satisfy the above-described condition.

In the Z-X plane, it is requested that the divergence angle of light is wide. On the other hand, the light emitted from the light source 6 has the divergence angle, in the Z-X plane, of 3 degrees represented as the full angle at half maximum. That is, the light 6a has a relatively small divergence angle in the Z-X plane. It is difficult for a lens having a general shape to widely broaden the divergence angle of substantially parallel light. As a configuration for widely broadening the angle, divergence plates are known such as a plate having a random irregular shape on its surface for diverging light and a plate containing micro particles in its material for diffusely reflecting light. However, in such a configuration, the degree of divergence and the light transmittance have a trade-off relationship. Thus, it is not desirable to employ such a configuration in a planar light source device where a reduction in power consumption is necessary.

Therefore, the light diffusion structure 70 is disposed in the Z-X plane in Embodiment 1. By employing the light diffusion structure 70, it becomes possible to widely broaden the divergence angle of substantially parallel light (light 6a) while reducing the decrease in light transmittance.

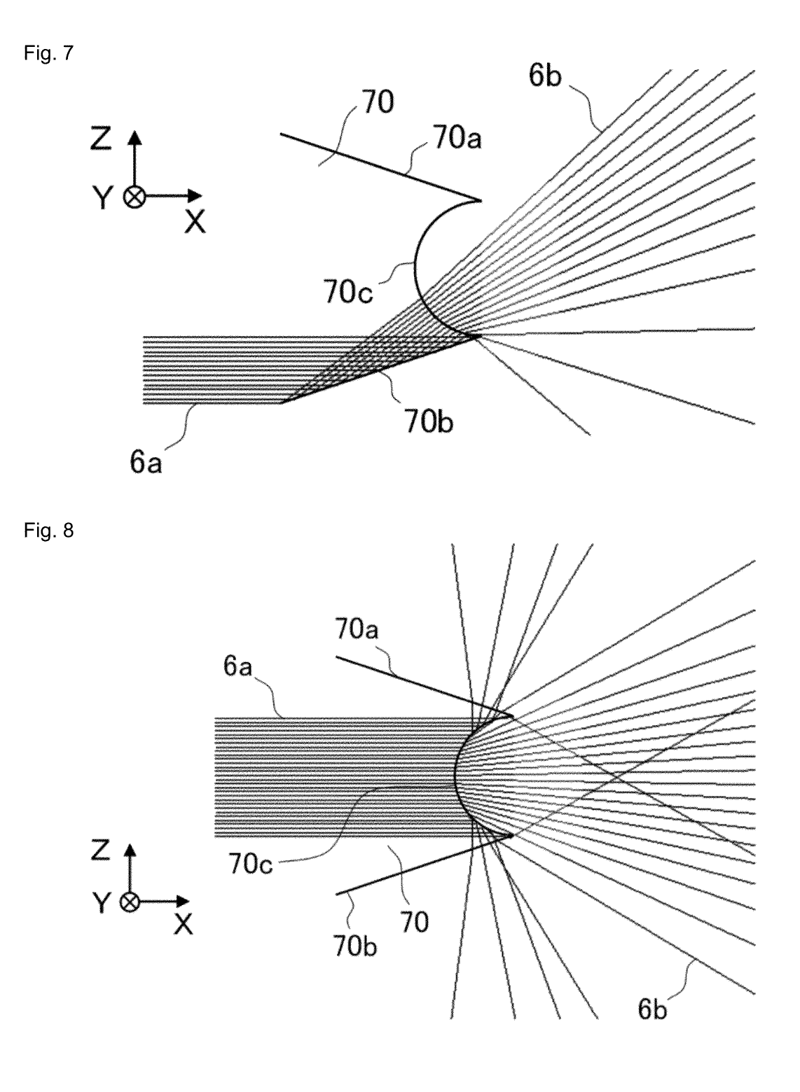

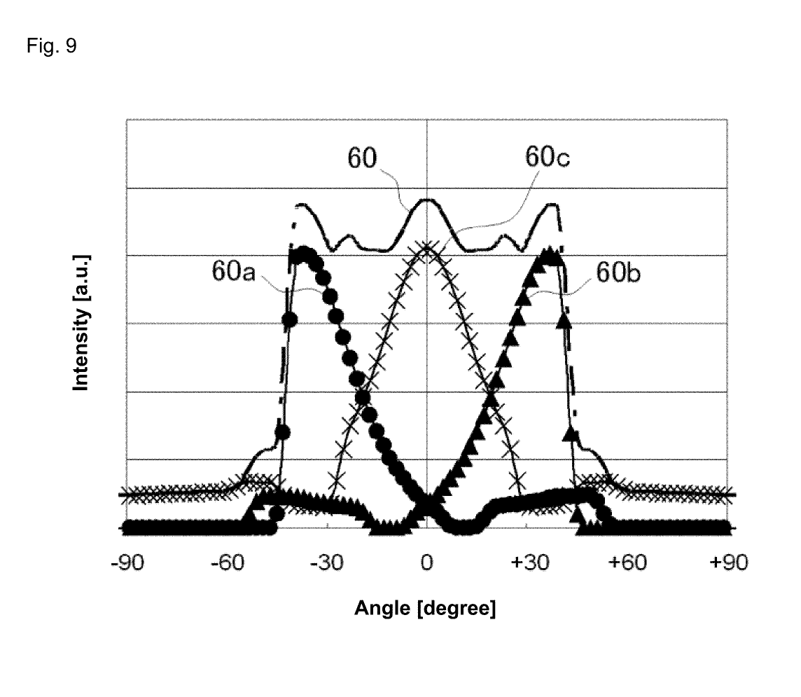

FIGS. 6, 7, and 8 are diagrams showing light behavior in the light diffusion structure 70. FIG. 9 is a graph showing the angular intensity distribution, in the Z-X plane, of light emitted from the light emission surface 7b. The horizontal axis shows the angle in degree and the vertical axis shows the light intensity in a.u. Here, the unit “a.u.” is an arbitrary unit and relative intensity is shown. Note that 0 degree in the angle in the graph in FIG. 9 is the X axis direction in FIG. 1. When viewed from the −Y axis direction and when the Y axis is assumed to be a rotational shaft, a clockwise rotational angle is set to be negative and a counter-clockwise rotational angle is set to be positive. As shown in FIGS. 6 through 8, the light (light 6a) entering the light diffusion structure 70 roughly follows three optical paths. Light in a first optical path enters the slant 70a of the light diffusion structure 70 (FIG. 6). Light in a second optical path enters the slant 70b of the light diffusion structure 70 (FIG. 7). Light in a third optical path enters the cylindrical surface 70c (FIG. 8).

As shown in FIG. 6, the light 6a which enters the slant 70a is totally reflected due to the refractive index difference, and thus the traveling direction thereof is slanted about −37 degrees with respect to the X axis direction in the Z-X plane. The light 6a totally reflected by the slant 70a enters the cylindrical surface 70c. The slant 70a is a total reflection surface. Because the cylindrical surface 70c has the perfect circle shape, the angular intensity distribution of the light 6a is broadened due to the lens effect. Therefore, as shown as a curve 60a in FIG. 9, the light 6a following the optical path shown in FIG. 6 is emitted from the light emission surface 7b as light having a divergence angle distribution, centered in the direction slanted −37 degrees with respect to the X axis direction in the Z-X plane, whose full angle at half maximum is about 25 degrees. In FIG. 9, the curve 60a is indicated by a solid line and marks “”.

As shown in FIG. 7, the light 6a which enters the slant 70b is totally reflected due to the refractive index difference, and thus the traveling direction thereof is slanted about +37 degrees with respect to the X axis direction in the Z-X plane. The light 6a totally reflected by the slant 70b enters the cylindrical surface 70c. The slant 70b is a total reflection surface. Because the cylindrical surface 70c has the perfect circle shape, the angular intensity distribution of the light 6a is broadened due to the lens effect. As shown as a curve 60b in FIG. 9, the light 6a following the optical path shown in FIG. 7 is emitted from the light emission surface 7b as light having a divergence angle distribution, centered in the direction slanted +37 degrees with respect to the X axis direction in the Z-X plane, whose full angle at half maximum is about 25 degrees. In FIG. 9, the curve 60b is indicated by a solid line and marks “▴”.

As shown in FIG. 8, the light 6a which directly enters the cylindrical surface 70c travels in the X axis direction without changing its traveling direction, and the angular intensity distribution thereof is broadened due to the lens effect based on the perfect circle shape of the cylindrical surface 70c. Therefore, as shown as a curve 60c in FIG. 9, the light 6c following the optical path shown in FIG. 8 is emitted from the light emission surface 7b as light having a divergence angle distribution, centered in the X axis direction in the Z-X plane, whose full angle at half maximum is about 36 degrees. In FIG. 9, the curve 60c is indicated by a solid line and marks “x”.

Based on the above description, the angular intensity distribution of light 6b emitted from the light emission surface 7b is obtained by summing each angular intensity distribution of light 60a, 60b, and 60c which follow the optical paths in FIGS. 6, 7, and 8, respectively, and the light 6b becomes light having a very wide divergence angle of 84 degrees represented as the full angle at half maximum, as shown as a curve 60 in FIG. 9. In FIG. 9, the curve 60 is indicated by a dashed line.

As it is clear from FIGS. 6 through 8, while achieving the very wide divergence angle, high light transmittance can be obtained in the light diffusion structure 70 in Embodiment 1, because an amount of light reflected backward (−X axis direction) with respect to the traveling direction of the light 6a is small.

If the plurality of light diffusion structures 70 are arranged in the Z axis direction, as is done in Embodiment 1, the light 6a can be more finely diverged. Thus, the illumination light 6c emitted from the planar light source device 210 becomes more uniform in its in-plane light intensity distribution. Note that, while a configuration is employed in the present embodiment in which three light diffusion structures 70 are arranged in the Z axis direction, the present invention should not be limited thereto. By increasing the number of light diffusion structures 70 to be arranged, it is possible to more finely diverge the light 6a, thereby being able to improve the uniformity of the in-plane light intensity distribution of the illumination light 6c.

While dimensions of the upper bottom, lower bottom, and height of the trapezoid used in the explanation of the shape of the light diffusion structure 70, and the concave shape of the upper bottom are shown in Embodiment 1, the present invention should not be limited thereto. The advantageous characteristic of the light diffusion structure 70 according to the present invention is that it has the following three functions. The first function is to divide light into components each of which follows one of the plurality of optical paths. The second function is to change the traveling direction of the light which follows at least one optical path from among the plurality of optical paths. The third function is to broaden the angular intensity distribution of all the light following the plurality of optical paths. Any dimension of each of the lower bottom and upper bottom of the trapezoid used in the explanation of the shape of the light diffusion structure 70, and any shape of the upper bottom portion are within the scope of the present invention regardless of the shape shown in Embodiment 1, as long as such a dimension and such a shape develop the above-described functions.

By adopting, as design parameters, the number of the light diffusion structures 70 to be arranged, the dimensions of the upper bottom, lower bottom, and height of the trapezoid formed in the light diffusion structure 70, and the shape of the upper bottom, it is possible to control the angular intensity distribution of the light 6b to be a desired shape.

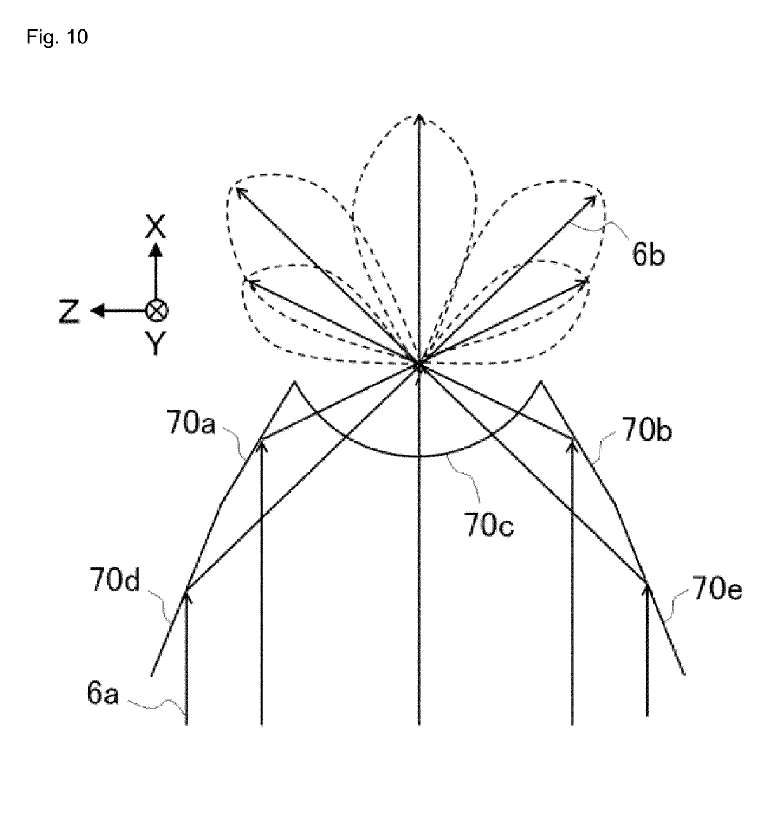

For example, as shown in FIG. 10, the slant 70a or 70b in the light diffusion structure 70 is divided into a plurality of surfaces in the Z-X plane, and the slant angle of each of the surfaces is varied. In FIG. 10, two divided slants 70a and 70d are disposed at the slant 70a side. Two divided slants 70b and 70e are disposed at the slant 70b side. In this way, the number of different optical paths that the light follows can be increased, thereby being able to more finely control the angular intensity distribution of the light 6b. The slants 70a, 70b, 70d, and 70e are slanted against the emitting direction of the light 6a. The slants 70d and 70e are total reflection surfaces same as the slants 70a, 70b. A distance between the slant 70d and the slant 70e increases as moving from their edges close to the cylindrical surface 70c (edges at +X axis direction side) toward the other edges thereof (edges at −X axis direction side). The other edges of the slants 70d and 70e (edges at −X axis direction side) are disposed at the incident side of the light 6a (−X axis direction side) with respect to the cylindrical surface 70c.

As shown in FIG. 10, the slants 70d and 70e are connected to the cylindrical surface 70c via the slants 70a and 70b, respectively. In such a shape, the slants 70d and 70e are disposed near the cylindrical surface 70c. The slants 70a and 70b are surfaces which are located near the edges of the cylindrical surface 70c and which are perpendicular to the reference plane (Z-X plane).

For example, it is possible to employ a free curved surface as a shape of the cylindrical surface 70c of the light diffusion structure 70.

Here, as shown in Embodiment 1, if the light diffusion structure 70 is configured with the three surfaces and if a simple shape such as the concave shape of the perfect circle is employed as the shape of a portion corresponding to the upper bottom of the trapezoid used in the explanation of the shape of the light diffusion structure 70, it is possible to improve the productivity.

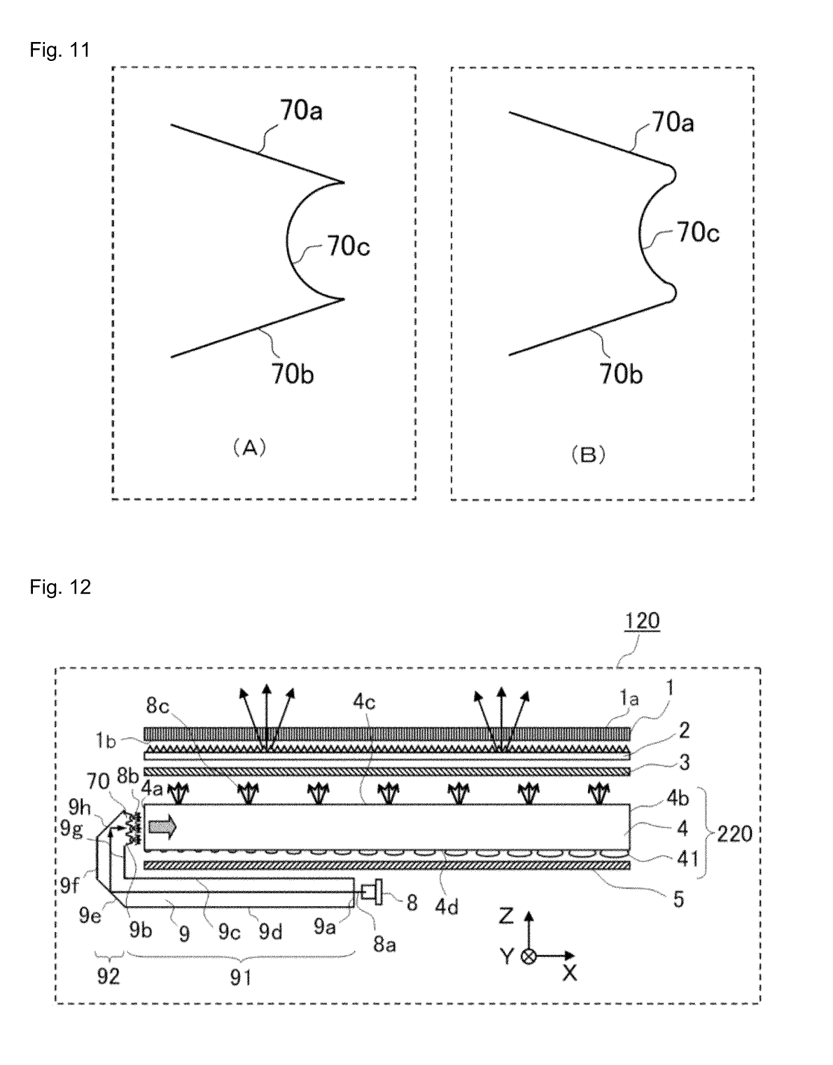

When considering the easy manufacturing and durability of a metal mold, and formability of parts, it is possible to somewhat simplify the shape so as to improve the productivity. For example, as the shape of a portion connecting the slant 70a and the cylindrical surface 70c or the shape of a portion connecting the slant 70b and the cylindrical surface 70c, a shape of (continuously) connecting them by an arc shown in (B) of FIG. 11 may be employed instead of a sharp angle (discontinuous) shape shown in (A) of FIG. 11 which is employed in Embodiment 1. High light diffusion characteristics can be obtained even if such a simplified shape is employed.

When the portions of connecting the slants 70a, 70b and the cylindrical surface 70c have the shapes for directly connecting them as shown in (A) of FIG. 11, the slants 70a and 70b are considered to be adjacent to the cylindrical surface 70c. When the portions of connecting the slants 70a, 70b and the cylindrical surface 70c have, for example, the shapes of (continuously) connecting them by the arc shown in (B) of FIG. 11, the slants 70a and 70b are considered to be near the cylindrical surface 70c. In this way, the slants 70a and 70b can be connected to the cylindrical surface 70c via a surface which is not related to the reflection of the light 6a. Here, “be near” means “be located near”. And “be adjacent to” means “be continuous side-by-side with”.

In the present invention, the direction (fast axis direction) in which the divergence angle of the light 6a emitted from the light source 6 is wide is set to be the laser element arranging direction, and the direction (slow axis direction) in which the divergence angle is narrow is set to be the light guide plate thickness direction. That is, the light source 6 is disposed so that the slow axis direction of the light 6a will be parallel to the Z axis direction. The Z axis direction is a direction in which the light diffusion structure 70 has the curvature. The reason is explained as follows. In the configuration of the present invention, the uniformity of the light intensity distribution in the laser element arranging direction (Y axis direction) is obtained by superimposing light 6a on other light 6a. If the length of the light intensity distribution conversion element 7 in the X axis direction is assumed to be constant, the uniformity of the light intensity distribution depends on the divergence angle of light and the number of laser elements. The X axis direction is the traveling direction of the light 6a. In other words, the uniformity of the light intensity distribution can be increased as the divergence angle of the light is broadened. The uniformity of the light intensity distribution can be increased as the number of laser elements is increased. Therefore, if the direction in which the divergence angle of the laser light is wide is set to be parallel to the laser element arranging direction (Y axis direction), it becomes possible to increase the uniformity of the light intensity distribution in the Y axis direction while reducing the number of laser elements.

On the other hand, if the direction (slow axis direction) in which the divergence angle of the laser light is narrow is set to be parallel to the light guide plate thickness direction, it becomes possible to reduce the thickness of the light intensity distribution conversion element 7 and the light guide plate 4. The reason is that, because the divergence angle of the light 6a is small, it is possible to cause all the light 6a to enter the light intensity distribution conversion element 7 even if the thickness of the light intensity distribution conversion element 7 is reduced. Additionally, because the thickness of the light intensity distribution conversion element 7 can be reduced, the thickness of the light 6b is also reduced. Thus, it is possible to cause all the light 6b to enter the light guide plate 4 even if the thickness of the light guide plate 4 is reduced. In the light diffusion structure 70 in Embodiment 1, since it is enough if a structure is designed in which the angular intensity distribution of light entering within only a narrow angle range is converted to the desired distribution and the light transmittance is increased, the design becomes easier. For example, because light entering with a wide angle range is totally reflected by the 70c, a problem arises in which the light is returned to the backward direction (direction of light incident surface 7a) thereby inviting the reduction in the light transmittance, etc.

As described above, according to the planar light source device 210 which has the light intensity distribution conversion element 7 in Embodiment 1, while the laser is employed as the light source 6, it becomes possible to obtain the planar illumination light 6c having high light utilization efficiency and having a spatial light intensity distribution with high uniformity. The liquid crystal display device 110 which has the planar light source device 210 is able to provide a high-quality image having a wide color reproduction range and low unevenness of brightness.

### Embodiment 2

FIG. 12 is a diagram schematically showing a configuration of a liquid crystal display device 120 which is a transmission type display device according to Embodiment 2 of the present invention. The liquid crystal display device 120 in Embodiment 2 is the same, except that a planar light source device 220 is different from the planar light source device 210, with the liquid crystal display device 110 in Embodiment 1. That is, the liquid crystal optical element 1, the optical sheets 2 and 3, and the light reflection sheet 5 are the same with those in the liquid crystal display device 110 in Embodiment 1. Configuring elements similar to those explained in the liquid crystal display device 110 in Embodiment 1 are indicated by the same reference numerals, and the detailed explanation thereof will be skipped.

The planar light source device 220 in Embodiment 2 has a light source 8, a light intensity distribution conversion element 9, and the light guide plate 4. The light guide plate 4 is a plate-like member, is made of a transparent material, has the light diffusion elements 41 on its rear surface 4d (surface of −Z axis side), and has a function of converting linear light into planar light. Since the above-described configuration is similar to that in Embodiment 1, the detailed explanation thereof will be skipped. The light source 8 has a configuration in which a plurality of laser elements are arranged in the one-dimensional direction. Each of the laser elements disposed in the light source 8 has a similar wavelength of light (for example, wavelength of red color light is 640 nm, that of green color light is 532 nm, and that of blue color light is 450 nm) with that in the light source 6 in Embodiment 1, and is a multi-mode semiconductor laser. A full angle at half maximum of the divergence angle in the fast axis direction is 40 degrees, and a full angle at half maximum of the divergence angle in the slow axis direction is 3 degrees. The fast axis direction is disposed to be parallel to the laser element arranging direction (Y axis direction in FIG. 1) and the slow axis direction is disposed to be parallel to the light guide plate thickness direction (Z axis direction in FIG. 1). Thus, since similar laser elements are employed, the detailed explanation thereof will be skipped.

Light 8a from the light source 8 is emitted toward the −X axis direction in FIG. 12. The light source 8 is disposed at the rear surface 4d side, which is a surface opposite to the front surface 4c of the light guide plate 4.

The light intensity distribution conversion element 9 is made of a transparent material. For example, an acryl resin (PMMA) or the like may be employed as the transparent material. The light intensity distribution conversion element 9 has a light guide unit 91 having a plate-like shape. The light guide unit 91 is disposed opposedly to the rear surface 4d of the light guide plate 4. The light intensity distribution conversion element 9 has an optical path changing unit 92 having two reflection surfaces. The light intensity distribution conversion element 9 may be a member whose thickness at a plate-like portion is 2 mm, for example. The length of the light intensity distribution conversion element 9 in its long side direction (Y axis direction in FIG. 12) is set to be equal to or shorter than the length of the light incident surface 4a of the light guide plate 4 in the Y axis direction in FIG. 1.

As shown in FIG. 12, a light incident surface 9a of the light intensity distribution conversion element 9 is a surface substantially parallel to the Y-Z plane in FIG. 12. The light incident surface 9a is disposed to face the light source 8. A light emission surface 9b of the light intensity distribution conversion element 9 is disposed to face the light incident surface 4a of the light guide plate 4. The light incident surface 4a is a surface substantially parallel to the Y-Z plane in FIG. 12. Both of main surfaces 9c, 9d of the light guide unit 91 of the light intensity distribution conversion element 9 are substantially parallel to the X-Y plane in FIG. 12. The main surface 9c is a surface located at the +Z axis direction side, and the main surface 9d is a surface located at the −Z axis direction side. The optical path changing unit 92 of the light intensity distribution conversion element 9 has two reflection surfaces 9e, 9h. The reflection surface 9e has a function of turning light 8a which travels in the +X axis direction through the light intensity distribution conversion element 9 toward the +Z axis direction. The reflection surface 9h has a function of turning the light 8a which travels in the +Z axis direction through the light intensity distribution conversion element 9 toward the +X axis direction. A surface 9g for connecting the main surface 9c and the light emission surface 9b, and a surface 9f for connecting the reflection surfaces 9e and 9h are substantially parallel to the Y-Z plane. The light intensity distribution conversion element 9 guides the light 8a from the light incident surface 9a toward the light incident surface 4a of the light guide plate 4.

The light intensity distribution conversion element 9 has a plurality of light diffusion structures 70 on the light emission surface 9b. The plurality of light diffusion structures 70 are arranged with a constant interval in the thickness direction (Z axis direction in FIG. 12) of the light guide plate 4. The light diffusion structure 70 has a configuration similar to that shown in Embodiment 1. That is, the following is similar to Embodiment 1. The light diffusion structure 70 has the two slants 70a, 70b and the cylindrical surface 70c, and has a structure similar to that shown in FIG. 5, at a cross section parallel to the Z-X plane (FIG. 12) of the light intensity distribution conversion element. The light 8a which enters the light intensity distribution conversion element 7 is subjected to, similar to the light 6a, a light refraction effect shown in FIGS. 5 through 8 at a plane parallel to the Z-X plane. The light diffusion structure 70 having the cross-sectional shape shown in FIG. 5 extends in the Y axis direction on the light emission surface 7b of the light intensity distribution conversion element 7. That is, when the light diffusion structure 70 is cut along the X-Y plane, the cross-sectional shape of the light emission surface 7b is a line parallel to the Y axis. Since the light diffusion structure 70 in Embodiment 2 has a structure similar to that in Embodiment 1, the detailed explanation thereof will be skipped.

The light intensity distribution conversion element 9 in Embodiment 2, similar to the light intensity distribution conversion element 7 in Embodiment 1, has a configuration in which light emitted from each of the neighboring laser elements are spatially overlapped by using the divergence angle thereof for the purpose of equalizing the spatial light intensity distribution in the laser elements arranging direction (Y axis direction) of the light source 8. Since the above-described configuration is similar to that in Embodiment 1, the detailed explanation thereof will be skipped.

In the planar light source device 220 in Embodiment 2, the light source 8 is disposed at the rear surface 4d side of the light guide plate 4 (−Z axis direction) and the most part of the light intensity distribution conversion element 9 are disposed at the rear surface 4d side of the light guide plate 4 (−Z axis direction). Recently, narrowing the structural portion (frame portion) disposed at the surrounding area of the screen is demanded for liquid crystal display devices. In Embodiment 2, it becomes possible to dispose the light source and the light intensity distribution conversion element, which are disposed at the frame portion of the liquid crystal display device in Embodiment 1, in the thickness direction of the liquid crystal display device. Thus, it becomes possible to narrow the frame portion of the liquid crystal display device 120. Also, in the configuration in Embodiment 2, since the length, in the X axis direction, of the light intensity distribution conversion element 9 can be increased, it is possible to improve the uniformity, in the Y axis direction, of the spatial light intensity distribution of the light 8a emitted from the light source 8. In addition, by increasing the length, in the X axis direction, of the light intensity distribution conversion element 9, it becomes possible to reduce the number of laser elements necessary to equalize the spatial light intensity distribution in the laser element arranging direction.

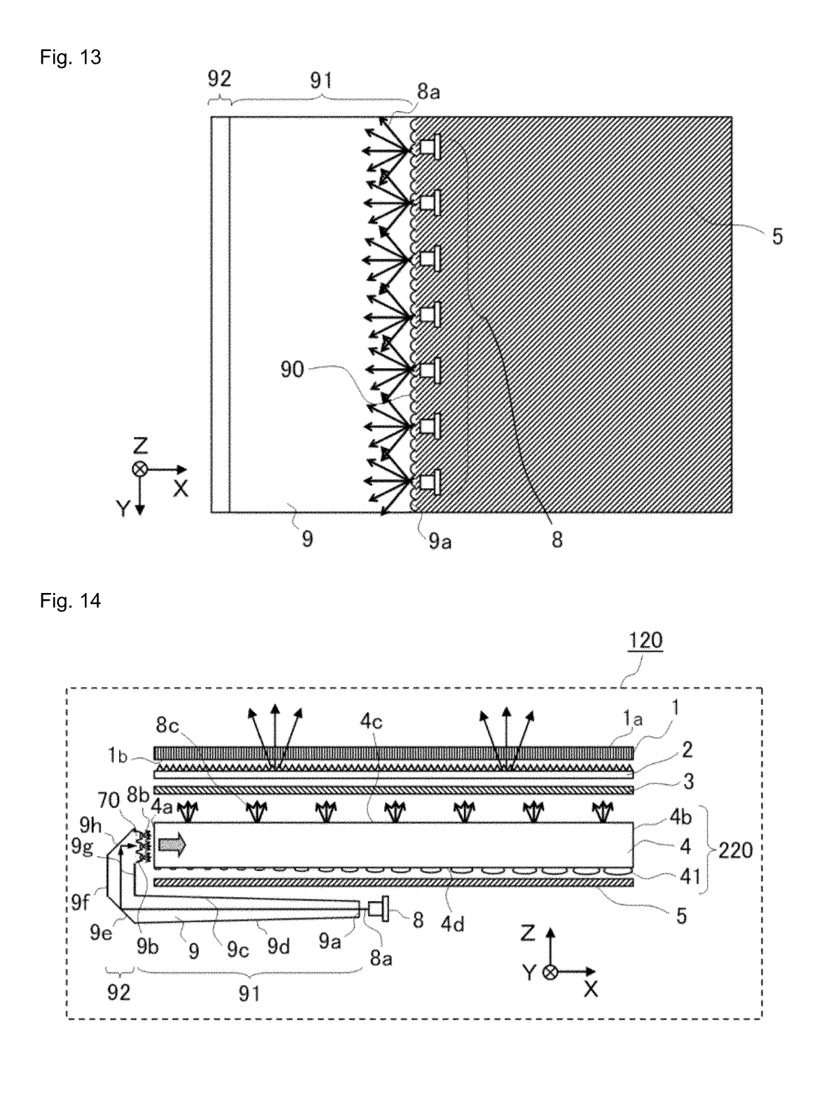

The light intensity distribution conversion element 9 in Embodiment 2 has a second light diffusion structure 90 in order to increase the uniformity of the spatial light intensity distribution in the laser element arranging direction (Y axis direction). FIG. 13 is a configuration diagram showing the planar light source device 220 when viewed from the −Z axis direction. As shown in FIG. 13, the light incident surface 9a of the light intensity distribution conversion element 9 has the light diffusion structure 90 which affects the light 8a only in the X-Y plane. A cross section, parallel to the X-Y plane, of the light diffusion structure 90 has a shape in which concave shapes of perfect circles, each having a radius of 0.02 mm and a depth of 0.01 mm, are arranged in the Y axis direction. That is, the concave shape is a shape having a concave in the −X axis direction. The centers of the perfect circles are arranged with a constant interval (0.04 mm) in the Y axis direction. Since the above-described cross-sectional shape is employed in the Z axis direction, the surface of the concave shape is formed by a part of a cylindrical surface having its central axis in the Z axis direction. The plurality of light diffusion structures 90 are arranged with an interval of 0.04 mm in the Y axis direction. The divergence angle, in the X-Y plane, of the light 8a which enters the light diffusion structure 90 is broadened by the light diffusion structure 90. That is, the light diffusion structure 90 diverges the light 8a in the Y axis direction. The Y axis direction is a direction where the cylindrical surface 70c does not have a curvature. Here, “diverge” means “broaden the divergence angle”. In this way, it is possible to improve the uniformity of the spatial light intensity distribution in the Y axis direction compared to a case where no light diffusion structure 90 is disposed. Thus, since the length of the light intensity distribution conversion element 9 in the X axis direction can be reduced, it becomes possible to downsize the light guide unit 91. Or, it becomes possible to reduce the number of laser elements provided in the light source 8. Note that the shaded portion in the right-hand side of the FIG. 13 is the light reflection sheet 5 disposed in the +Z axis direction of the light guide unit 91.

As shown in FIG. 14, the light intensity distribution conversion element 9 in Embodiment 2 may have a shape in which the main surfaces 9c and 9d of the light guide unit 91 are not parallel. More precisely, the light guide unit 91 of the light intensity distribution conversion element 9 has a shape whose thickness (dimension in Z axis direction in Z-X plane) increases as moving from the light incident surface 9a toward the optical path changing unit 92. That is, the light guide unit 91 has the shape whose thickness increases from the light incident surface 9a toward the traveling direction of the light 8a. The thickness means a dimension in a direction (Z axis direction) perpendicular to the traveling direction of the light 8a (−X axis direction) in the Z-X plane (reference plane). This shape is what is called a wedge shape. The light guide unit 91 is wedge-shaped.

If the above-described wedge shape is employed, it becomes possible to make the light 8a which enters the light intensity distribution conversion element 9, to be substantially parallel light by reducing the divergence angle thereof in the Z-X plane. By converting the light 8 into the substantially parallel light, it becomes easy to design a structure in which the reflection surfaces 9e, 9h in the optical path changing unit 92 have high reflectance. Also, by converting the light 8 into the substantially parallel light, it becomes possible to improve the light transmittance in the light diffusion structure 70 disposed on the light emission surface 9b. As described above, employing the wedge shape whose thickness increases toward the −X axis direction as a shape, in the Z-X plane, of the light guide unit 91 of the light intensity distribution conversion element 9 is effective, especially when the divergence angle of the laser light in the Z-X plane is large.

In Embodiment 2, the slow axis direction of the laser elements is disposed parallel to the light guide plate thickness direction (Z axis direction in FIG. 1). Therefore, the wedge-shaped light guide unit 91 is effective when the divergence angle in the slow axis direction is comparatively large.

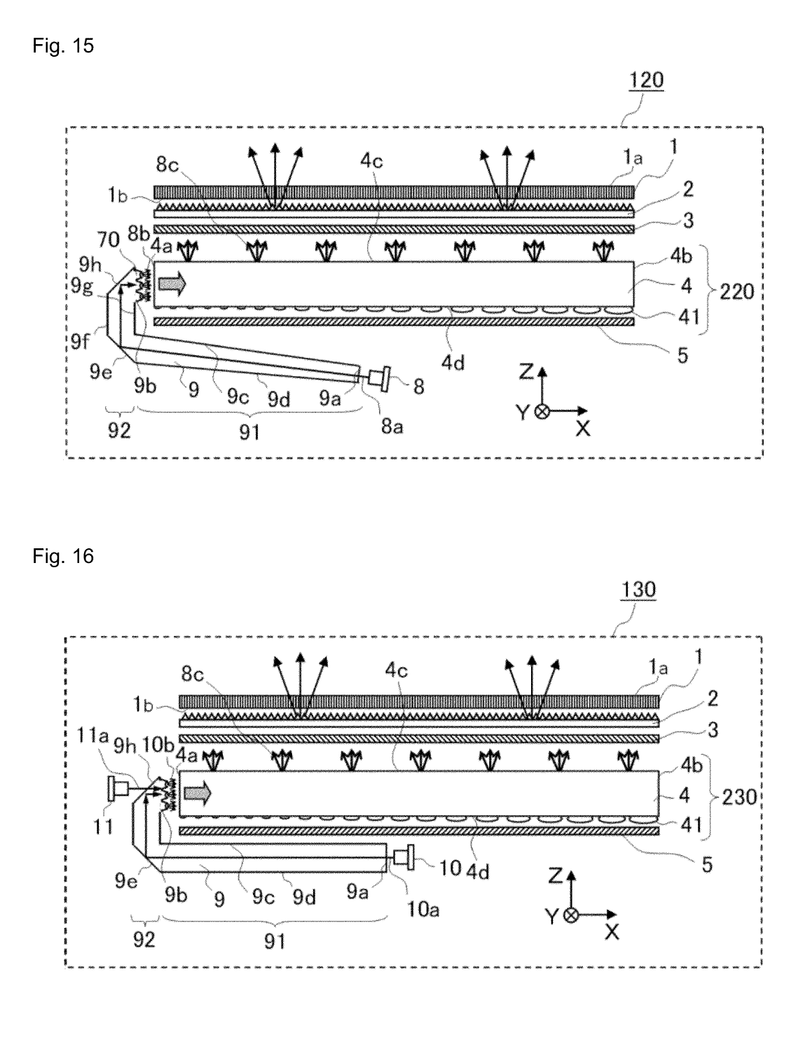

As shown in FIG. 15, the light intensity distribution conversion element 9 may have a configuration in which the angle between the light 8a propagating through the light guide unit 91 in the −X axis direction and the light 8a propagating through the optical path changing unit 92 in the +Z axis direction is not a right angle (90 degrees). The shape of the light intensity distribution conversion element 9 is designed so that the angle between the light 8a and each of the reflection surfaces 9e, 9h will satisfy the total reflection condition based on the Snell's law. In this way, reflectance of the light 8a at the reflection surfaces 9e, 9h can be improved. Because it is possible to dispose the light incident surface 9a of the light intensity distribution conversion element 9 in the direction of getting away from the light guide plate 4 (−Z axis direction), the configuration shown in FIG. 15 is effective in a case when the dimension of the light source 8 is large. In other wards, it is effective when large laser elements are employed in the light source 8.

As described above, according to the planar light source device 220 which has the light intensity distribution conversion element 9 in Embodiment 2, while the laser is employed as the light source, it becomes possible to obtain planar illumination light 8c having high light utilization efficiency and having a spatial light intensity distribution with high uniformity. The liquid crystal display device 120 which has the planar light source device 220 is able to provide a high-quality image having a wide color reproduction range and low unevenness of brightness. Also, in Embodiment 2, it becomes possible to narrow the frame portion by disposing the light source 8 and the most part of the light intensity distribution conversion element 9 in the thickness direction of the liquid crystal display device 220.

### Embodiment 3

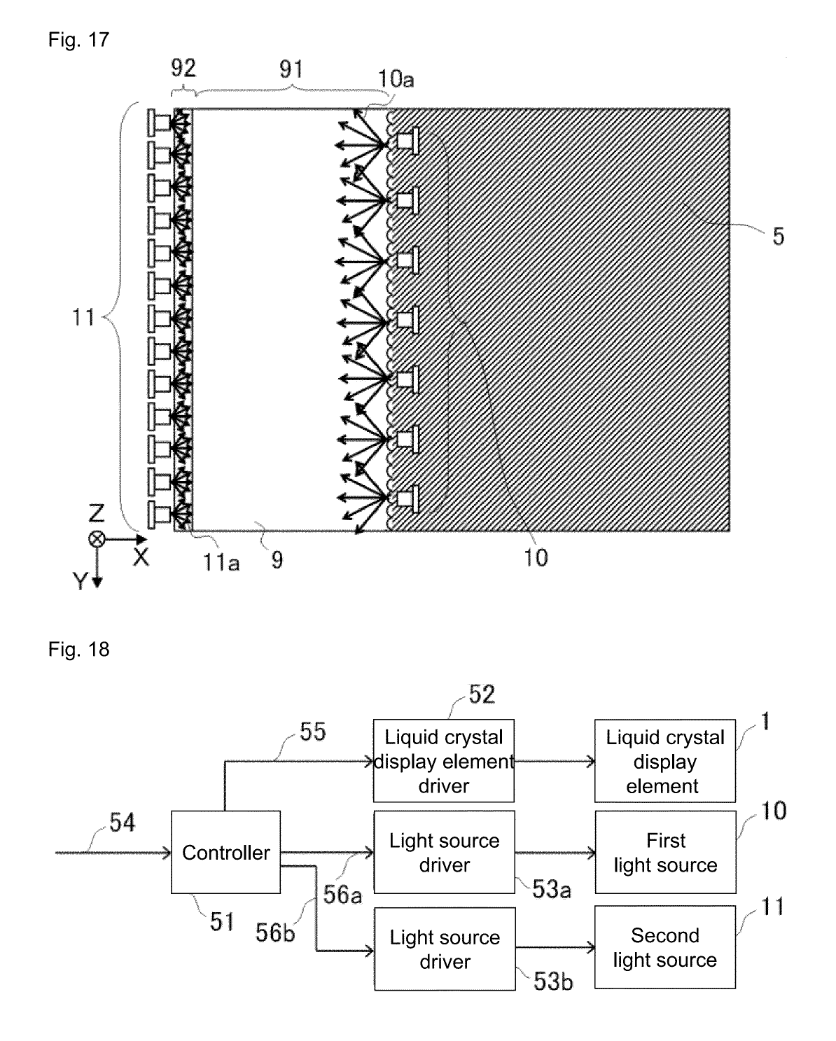

FIG. 16 is a diagram schematically showing a configuration of a liquid crystal display device 130 which is a transmission type display device according to Embodiment 3 of the present invention. FIG. 17 is a configuration diagram showing a planar light source device 230 when viewed from the −Z axis direction. In the liquid crystal display device 130 in Embodiment 3, the planar light source device 230 is different from the planar light source device 220 in Embodiment 2 in a manner that a first light source 10 is disposed instead of the light source 8 and a second light source 11 is further disposed. That is, the liquid crystal optical element 1, the optical sheets 2 and 3, the light guide plate 4, the light reflection sheet 5, and the light intensity distribution conversion element 9 are the same with those in the liquid crystal display device 120 in Embodiment 2. The same will apply to the configuring elements in the liquid crystal display device 120 in Embodiment 2 which are the same with those in the liquid crystal display device 110 in Embodiment 1. Configuring elements similar to those explained in the liquid crystal display device 120 in Embodiment 2 are indicated by the same reference numerals, and the detailed explanation thereof will be skipped.

The light source 10 is a first light source. As shown in FIG. 17, a plurality of laser elements are one-dimensionally arranged in the Y axis direction in the light source 10. The laser elements disposed in the light source 10 emit red color light which has a wavelength of 640 nm, for example. The light emitted from the light source 10 has a direction whose divergence angle is wide (fast axis direction) and another direction, which is perpendicular thereto, whose divergence angle is narrow (slow axis direction). In the planar light source device 230 in Embodiment 3, the laser elements are arranged so that the fast axis direction will be parallel to the laser element arranging direction (Y axis direction) and the slow axis direction will be parallel to the thickness direction (Z axis direction) of the light intensity distribution conversion element 9.

Light 10a emitted from the first light source 10 is emitted from the light emission surface 9b of the light intensity distribution conversion element 9 toward the light incident surface 4a of the light guide plate 4. The light emitted from the light emission surface 9b is light 10b. Because behavior in the light intensity distribution conversion element 9 while the light 10a becomes the light 10b is similar to the behavior while the light 8a becomes the light 8b in Embodiment 2, the explanation thereof will be skipped. That is, after traveling through the light intensity distribution conversion element 9 in the −X axis direction, the light 10a changes its traveling direction to the +Z axis direction by the reflection surface 9e, and then changes its traveling direction from the +Z axis direction to the +X axis direction by the reflection surface 9h.

The light source 11 is the second light source. In the light source 11, a plurality of LED elements are one-dimensionally arranged in the Y axis direction. The light source 11 is disposed in a plane substantially the same with that of the light guide plate 4 which is parallel to the X-Y plane. That is, the light source 11 is disposed to face the light incident surface 4a of the light guide plate 4. The light emitting surface of the light source 11 is directed to the +X axis direction. That is, light 11a emitted from the light source 11 is emitted toward the light incident surface 4a. The light 11a enters the light guide plate 4 through the light incident surface 4a.

The light 11a emitted from the light source 11 is blue-green color light. The blue-green color light has its peaks at around 450 nm and around 530 nm, for example, and has a continuous spectrum at a bandwidth from 420 nm through 580 nm. The LED element disposed in the light source 11 is, for example, a device in which a package having a blue color LED chip that emits blue color light is filled with a green color fluorescent material that absorbs blue color light and emits green color light. Or, the LED element disposed in the light source 11 is, for example, a device in which a light source other than the LED is employed as an excitation light source and a green color fluorescent material is excited using the excitation light source to emit blue-green color light. Or, the light source 11 is, for example, a device in which blue-green color light is emitted by exciting a fluorescent material that emits blue color light and green color light using a light source that emits light whose wavelength is in an ultraviolet region. Or, the light source 11 is, for example, a device in which a blue color LED chip that emits blue color light and a green color LED chip are disposed.

The light source 11 has an angular intensity distribution of a Lambert distribution whose full angle at half maximum is 120 degrees in the X-Y plane and the Z-X plane. The light 11a has a wider divergence angle than that of the light 10a.

The light 11a emitted from the light source 11 in the +X axis direction transmits through the optical path changing unit 92 of the light intensity distribution conversion element 9 to be emitted from the light emission surface 9b, and enters the light guide plate 4 through the light incident surface 4a. The light 11a emitted from the light source 11 has a very wide divergence angle. The light 10a emitted from the light source 10 has high directivity and a narrow divergence angle. The light 11a has a wider divergence angle than that of the light 10a. The plurality of LED elements are arranged in the Y axis direction. Therefore, the blue-green light contained in the illumination light 8c emitted from the light guide plate 4 toward the liquid crystal display element becomes light having a uniform spatial intensity distribution in the X-Y plane.

The red color light 10b and the blue-green color light 11a are merged before entering the light guide plate 4, to enter the light guide plate 4 as white color linear light. Then, the light 10b and the light 11a are emitted from the light guide plate 4 as the white color planar illumination light 8c for illuminating the liquid crystal display element 1. As described above, the red color light 10b and the blue-green color light 11a contained in the illumination light 8c each generate light having a spatial intensity distribution with high uniformity in the X-Y plane. Therefore, the illumination light 8c becomes white color planar light having a spatial intensity distribution with high uniformity in the X-Y plane.

In Embodiment 3, a laser element having excellent monochromaticity is employed only for the red color. The reason is that, from among the semiconductor lasers most suitable for applying to the display use, the red color one has the most excellent productivity at present. In addition, another reason is that, especially in green color semiconductor lasers, sufficient output power has not been obtained yet. In order to obtain green color light more efficiently, the most suitable method is to obtain it by exciting a green color fluorescent material with another color light.

The reason is as follows. Semiconductor lasers or LEDs of a near ultraviolet region and a blue color used for exciting a green color fluorescent material have higher luminous efficiency than that of green color semiconductor lasers. In addition, the green color fluorescent material has a high light absorption rate and high internal conversion efficiency for the light of the near ultraviolet region and the blue color. Thus, the luminous efficiency of devices utilizing the fluorescent material is higher than that of the green color semiconductor lasers at present.

In Embodiment 3, blue color LED elements are employed as the excitation light source for the fluorescent material. The reason is that, when a configuration is employed in which a fluorescent material is excited by a blue color light emitting element to obtain another color light, as is done in the light source 11 in Embodiment 3, it is desirable to employ LEDs rather than lasers.

The reason is as follows. While the LEDs are driven by low current and have low output power, the lasers are driven by high current and have high output power. Thus, a very large amount of heat is generated by the lasers during driving. While light emitted from the LED has a wide divergence angle, light emitted from the laser has a very narrow divergence angle. Thus, intensity density of exciting light which enters the fluorescent material (intensity of light entering unit volume of fluorescent material) becomes very high in the laser. As for the light which enters the fluorescent material and is absorbed thereby, part of it is converted into light having another wavelength and is emitted toward the outside, and the other part of it mainly becomes thermal energy. The internal conversion efficiency of the fluorescent material (ratio of amount of light converted into light having another wavelength to amount of light absorbed) is between about 40% and 80% in general. That is, the thermal energy concurrently generated reaches as much as between 20% and 60% of light energy which enters. Thus, a very large amount of heat is generated in the fluorescent material when laser light having high output power and high density of light intensity enters.

When the amount of heat generated by the laser itself which has the fluorescent material increases, the temperature of the fluorescent material increases. Increasing the amount of heat generated by the fluorescent material itself causes the temperature of the fluorescent material to increase. When the temperature of the fluorescent material increases, the internal conversion efficiency of the fluorescent material significantly decreases, to cause the reduction in brightness and the increase in power consumption. Therefore, in the light source 11 in Embodiment 3, blue-green color LEDs are employed each having a blue color LED and a fluorescent material which emits green color light when excited by the blue color light therefrom.

Humans have high sensitivity for a color difference in a red color. Therefore, the humans feel the difference in wavelength bandwidth in the red color as a significant difference. Here, the difference in wavelength bandwidth is a difference in color purity. Conventional white color light generated by CCFLs and LEDs has particularly a small amount of red color light and has low color purity due to a wide wavelength bandwidth. Thus, in liquid crystal display devices in which CCFLs and LEDs are used as light sources, the color reproduction range of red color and the amount of power consumption have a trade-off relationship. That is, the trade-off is between securing the color reproduction range with the increased amount of red color light by increasing an amount of light from the while color CCFLs and LEDs, and saving the electric power by narrowing the color reproduction range.

On the other hand, since the laser has a narrow wavelength bandwidth, high color purity can be obtained without causing a light loss. Based on the above reasons, if the laser light is employed particularly for the red color from among three primary colors, an effect for reducing the amount of power consumption can be obtained. That is, because the laser light has very high monochromaticity and has good transmittance in a red color filter, a sufficient amount of red color light can be secured without increasing the amount of light, thereby being able to obtain the effect for reducing the amount of power consumption. In addition, since the laser light has high monochromaticity, color purity is improved and thus an effect of broadening the color reproduction range is obtained. Based on the above reasons, the liquid crystal display device 130 in Embodiment 3 employs the laser as the red color light source.

In conventional liquid crystal display devices in which CCFLs and LEDs are used as light sources, red color light has a wide wavelength bandwidth. Thus, part of red color light transmits a filter of the green color which has an adjacent spectrum to the red color. In this way, in the conventional liquid crystal display devices in which CCFLs and LEDs are used as light sources, color purity of green color light is also decreased. However, in the liquid crystal display device 130 in Embodiment 3, since the color purity is increased, the amount of red color light which transmits the green color filter is decreased, and thus it is possible to improve the color purity of green color light. Therefore, an effect of broadening the color reproduction range can be obtained.

In Embodiment 3, the first light source 10 is configured with the laser elements each of which emits red color light. And the second light source 11 is configured with the LED elements each of which emits blue-green color light. However, the present invention should not be limited thereto. Based on the above reasons, it is possible to configure the first light source 10 with laser elements each of which emits red color light and with laser elements each of which emits blue color light, and to configure the second light source 11 with LED elements each of which emits green color light, for example. Or, it is possible to configure the first light source 10 with laser elements each of which emits blue color light, and to configure the second light source 11 with LED elements each of which emits red color light and LED elements each of which emits green color light, for example. Note that it is possible to show a significant difference against a conventional liquid crystal display device if the laser light source is employed only for the red color, rather than employing the laser light source only for the blue color.

In the planar light source device 230 in Embodiment 3, the most suitable configuration is that the first light source 10 is a light source having laser elements and the second light source 11 is a light source having LED elements.

It becomes possible to reduce the light loss by employing a light source having laser elements with a narrow divergence angle as the first light source 10. If the light source 10 is assumed to have a light source having a wide divergence angle, the refractive index is decreased at the reflection surfaces 9e, 9h of the light intensity distribution conversion element 9. Especially, since it is necessary to transmit the light 11a from the second light source 11, the reflection surface 9h needs to be a reflection surface in which the refractive index difference is utilized, and the divergence angle of the light source 10 depends on the refractive index. As to the reflection surface 9e, a mirror may be formed by depositing metal. Note that it is desirable that the reflection surface 9e is also a reflection surface in which the refractive index difference is utilized in order to avoid a complicated manufacturing process of the light intensity distribution conversion element 9.

Since the first light source 10 is a light source which has laser elements having a narrow divergence angle, it is difficult to improve the uniformity in the laser element arranging direction (Y axis direction). However, in Embodiment 3, the light intensity distribution conversion element 9 is disposed in the thickness direction (−Z axis direction) of the liquid crystal display device 130. Therefore, it becomes possible to provide a more sufficient optical distance (length of light guide unit 91 of light intensity distribution conversion element 9) without broadening the frame portion of the liquid crystal display device 130 so as to improve the uniformity in the laser element arranging direction (Y axis direction).

Since the second light source 11 is a light source which has LED elements having a wide divergence angle, it is possible to obtain the illumination light 8c having a uniform spatial light intensity distribution by the use of its own divergence angle without disposing an optical element between the light source 11 and the light guide plate 4. If the light source 11 is assumed to have a light source having a narrow divergence angle, it becomes difficult to obtain the illumination light 8c having a uniform spatial light intensity distribution. The reason is that, since light 11a does not sufficiently overlaps with neighboring light 11a before entering the light guide plate 4, uniform linear light is not obtained and unevenness of brightness is generated.

In Embodiment 3, the light source 11 is configured with LED elements each having a divergence angle whose full angle at half maximum is 120 degrees. However, the present invention should not be limited thereto. For example, the divergence angle may be controlled by disposing a lens on the light emitting surface of the LED element. As another example, a cylindrical lens for decreasing the divergence angle only in the Z-X plane may be disposed. In this way, it becomes possible to increase an amount of light to be coupled in the light guide plate 4 from among the light 11a (optical coupling efficiency). Note that, since the uniformity of spatial light intensity distribution of the illumination light 8c decreases if the divergence angle is made to be too narrow as described above, it is necessary to optimize the shape of the lens under the consideration of the optical coupling efficiency and the divergence angle.

In Embodiment 3, it is possible to reduce power consumption by controlling the luminescence amounts of the light source 10 and the light source 11 separately. FIG. 18 is a block diagram showing an operation method for the liquid crystal display element 1, the light source 10, and the light source 11. The liquid crystal display element driver 52 drives the liquid crystal display element 1. A light source driver 53a drives the light source 10 serving as the first light source. A light source driver 53b drives the light source 11 serving as the second light source. The controller 51 controls the liquid crystal display element driver 52 and the light source drivers 53a, 53b.

For example, if the light source drivers 53a and 53b are separately controlled by the controller 51, it is possible to adjust the balance between an amount of red color light emitted from the first light source 10 and an amount of blue-green color light emitted from the second light source 11. The controller 51 outputs a light source control signal 56a to the light source driver 53a. The controller 51 outputs a light source control signal 56b to the light source driver 53b. Thus, it is possible to achieve a reduction in power consumption by adjusting the luminescence amount of each of the light sources in accordance with the balance of light intensity for each of the colors necessary for each of the image signals 54.

As described above, in the planar light source device 230 in Embodiment 3, while the laser is employed as the light source, it becomes possible to obtain planar illumination light 8c having high light utilization efficiency and having a spatial light intensity distribution with high uniformity. The liquid crystal display device 130 which has the planar light source device 230 is able to provide a high-quality image having a wide color reproduction range and low unevenness of brightness. In Embodiment 3, it becomes possible to narrow the frame portion by disposing the light source 10 and the most part of the light intensity distribution conversion element 9 in the thickness direction (Z axis direction) of the liquid crystal display device 230. Also, since the red color light is formed by the laser element and the blue-green color light is formed by the LED element, both of broadening the color reproduction range and reducing the power consumption, which have been challenges in conventional liquid crystal display devices, can be achieved. In addition, by employing a simplified configuration, it becomes possible to provide a liquid crystal display device having high productivity.

### Embodiment 4

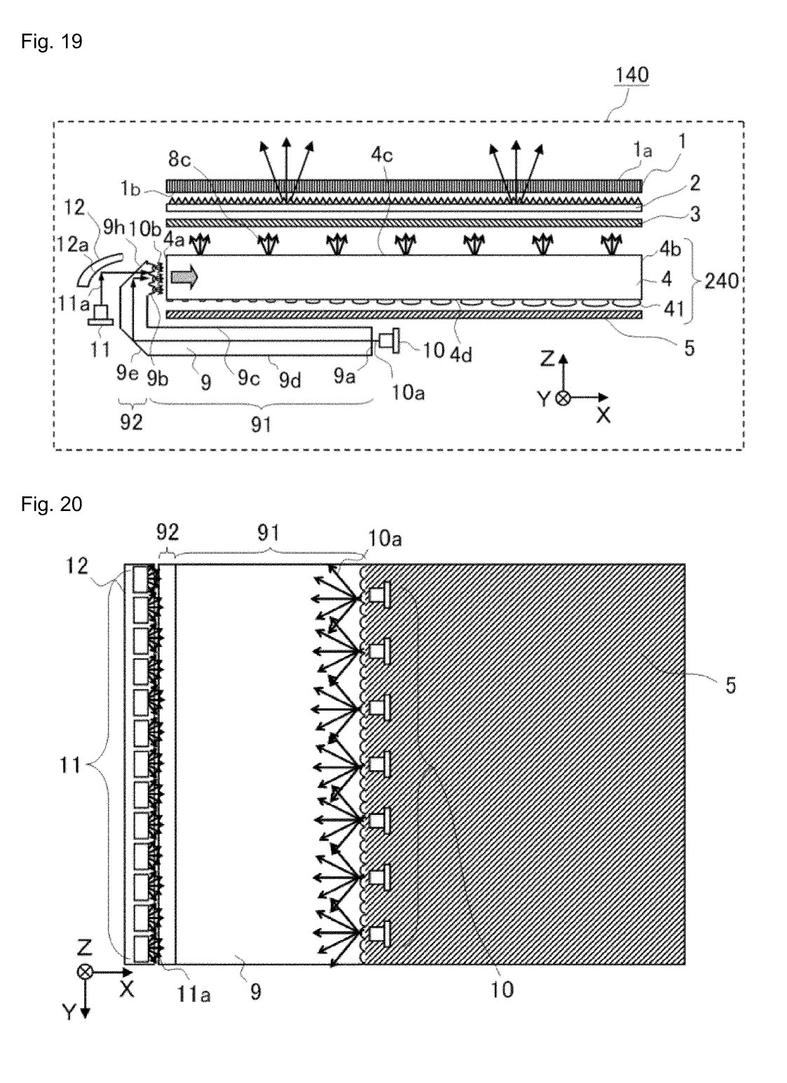

FIG. 19 is a diagram schematically showing a configuration of a liquid crystal display device 140 which is a transmission type display device according to Embodiment 4 of the present invention. FIG. 20 is a configuration diagram showing a planar light source device 240 when viewed from the −Z axis direction. The planar light source device 240 in the liquid crystal display device 140 in Embodiment 4 is different from the planar light source device 230 in Embodiment 3 in a manner that the second light source 11 is disposed at a different position and a reflection member 12 is disposed. That is, the liquid crystal optical element 1, the optical sheets 2 and 3, the light guide plate 4, the light reflection sheet 5, the light intensity distribution conversion element 9, and the light source 10 are the same with those in the liquid crystal display device 130 in Embodiment 3. The light source 11 is the same with that in the liquid crystal display device 130 in Embodiment 3, other than the disposed position thereof. The same will apply to the configuring elements in the liquid crystal display device 130 in Embodiment 2 which are the same with those in the liquid crystal display device 110 in Embodiment 1 and in the liquid crystal display device 1210 in Embodiment 2. Configuring elements similar to those explained in the liquid crystal display device 130 in Embodiment 3 are indicated by the same reference numerals, and the detailed explanation thereof will be skipped.

As shown in FIG. 19, the light source 11 is disposed in the direction (−Z axis direction) of the rear surface 4d side of the light guide plate 4. That is, the light source 11 is disposed in the opposite direction of the front surface 4c of the light guide plate 4 with respect to the light guide plate 4. A light emitting surface of the light source 11 is directed in the +Z axis direction. In other words, the light 11a is emitted in the +Z axis direction. The traveling direction of the light 11a is changed to the +X axis direction by the reflection member 12. The light 11a enters the light guide plate 4 through the light incident surface 4a.

The reflection member 12 is disposed between the light source 11 and the light intensity distribution conversion element 9. The reflection member 12 has a reflection surface 12a. The reflection member 12 is made of, for example, an acryl resin (PMMA), polycarbonate (PC), or a metal such as aluminum. The reflection surface 12a can be formed by depositing aluminum, gold, silver, or the like on the above-described acryl resin, etc. Or, the reflection member 12 may be made of resin having high reflectance so that the reflection surface 12a will be provided without depositing metal. The reflection surface 12a is disposed to face the light source 11, and to face the reflection surface 9h of the light intensity distribution conversion element 9 and the light incident surface 4a of the light guide plate 4. The reason why the reflection surface 12a is disposed to face the light source 11, the reflection surface 9h, and the light incident surface 4a is that a configuration is employed in which the light 11a emitted from the light source 11 is reflected by the reflection surface 12a, and then transmits through the reflection surface 9h so as to enter the light guide plate 4 through the light incident surface 4a.

The light 11a from the light source 11 is emitted in the +Z axis direction, and is changed to light, which travels in the +X axis direction, by the reflection surface 12a of the reflection member 12. The light 11a reflected by the reflection surface 12a transmits through the reflection surface 9h of the light intensity distribution conversion element 9 and enters the light guide plate 4.

The reflection member 12 has a curvature in the Z-X plane and is extended in the Y axis direction. That is, the reflection member 12 has the curvature in a plane parallel to the Z-X plane. The reflection member 12 has a shape cut out from an ellipse in the Z-X plane. One of the focuses of the elliptical shape is located at the light emitting surface center of the light source 11. The other focus is located at the center of the light incident surface 4a of the light guide plate 4. The light source 11 is the second light source. That is, the reflection member 12 has the reflection surface 12a whose cross-sectional surface perpendicular to the Y axis direction is a part of the ellipse having its paired focuses at the light emitting surface center of the light source 11 and at the center of the light incident surface 4a. The Y axis direction is a direction where the cylindrical surface 70c does not have the curvature. In this way, light emitted from the light source 11 can be efficiently coupled in the light guide plate 4. Here, if a design is made under the consideration of an optical influence caused by transmitting through the light intensity distribution conversion element 9 while traveling from the reflection member 12 to the light guide plate 4, the light 11a can be more efficiently coupled in the light guide plate 4.

In the planar light source device 240 in Embodiment 4, when LEDs have a wide divergence angle, part of light therefrom is directly guided to the light incident surface 4a of the light guide plate 4 without the intervention of the reflection surface 12a. Thus, it becomes possible to downsize the reflection member 12 without the decrease in efficiency when the light 11a from the light source 11 is coupled in the light guide plate 4.

As described above, in the planar light source device 240 in Embodiment 4, while the laser is employed as the light source 10, it becomes possible to obtain planar illumination light 8c having high light utilization efficiency and having a spatial light intensity distribution with high uniformity. The liquid crystal display device 140 which has the planar light source device 240 is able to provide a high-quality image having a wide color reproduction range and low unevenness of brightness. In Embodiment 4, it becomes possible to narrow the frame portion by disposing the light source 10 and the most part of the light intensity distribution conversion element 9 in the thickness direction (−Z axis direction) of the liquid crystal display device 240. Also, since the red color light is formed by the laser element and the blue-green color light is formed by the LED element, both of broadening the color reproduction range and reducing the power consumption, which have been challenges in conventional liquid crystal display devices, can be achieved. In addition, by employing a simplified configuration, it becomes possible to provide a liquid crystal display device having high productivity. Furthermore, since the light 11a from the light source 11, which has a wide divergence angle, can be coupled in the light guide plate 4 with high efficiency, it is possible to suppress the increase of power consumption.

In the above-described embodiments, the cylindrical surface 70c is configured with a cylindrical lens. In the embodiments, a cylindrical lens having a concave shape is employed. In the cylindrical surface 70c, the generating line direction of the lens surface of the cylindrical lens is the Y axis direction. The direction of a line perpendicular to the two generating lines located at the edges of the lens surface from among lines connecting the two generating lines located at the edges of the lens surface of the cylindrical lens is the Z axis direction. The characteristic of the invention in the present application is that the light 6a totally reflected by the slants 70a, 70b is emitted from the cylindrical surface 70c so as to improve the uniformity of its spatial light intensity distribution while keeping high light utilization efficiency. Thus, for example, a configuration may be employed in which a shape acquired by rotating, around the optical axis of the cylindrical surface 70c, the light diffusion structures 70 shown in (A) of FIG. 11 or (B) of FIG. 11 are arranged on the light emission surface 7b. An effect equivalent to that in the above-described embodiments can be obtained in this configuration.

However, it is difficult to manufacture such a configuration in which the above-described circular-truncated-cone like shapes are arranged on the light emission surface 7b. When manufactured using a resin mold method, both forming the resin and manufacturing its metal mold are difficult. Based on this consideration, the configuration shown in the above-described embodiments, in which the cylindrical surface 70c is used as the cylindrical lens, is superior in terms of easy manufacturability from the view point of manufacturing the light diffusion structure 70.

In the above-described embodiments, there may be a case in which an expression accompanied by a word “substantially” is used, such as a surface substantially parallel to, substantially parallel light, or a substantially Gaussian shape. These expressions represent that they include some range depending on tolerances in manufacturing, errors in assembling, and the like. Therefore, even if “substantially” is not described in the claims, some range depending on tolerances in manufacturing, errors in assembling, and the like is regarded to be included. When “substantially” is described in the claims, it shows that some range depending on tolerances in manufacturing, errors in assembling, and the like is included. In addition, the description of “is disposed in a plane substantially the same with that of” means “is disposed to face”, as described above.

Note that, while the embodiments of the present invention are explained above, the present invention should not be limited to the embodiments.

### REFERENCE NUMERALS

1: liquid crystal optical element; 1a: display surface; 1b: rear surface; 210, 220, 230, 240: planar light source devices; 2, 3: optical sheets; 4: light guide plate; 4a: light incident surface; 4b: surface; 4c: front surface; 4d: rear surface; 41: light diffusion element; 5: light reflection sheet; 51: controller; 52: liquid crystal display element driver; 53, 53R, 53G, 53B, 53a, 53b: light source drivers; 54: image signal; 55: liquid crystal display element control signal; 56, 56a, 56b: light source control signals; 6, 8, 10, 11: light sources; 12: reflection member; 12a: reflection surface; 6a, 8a, 10a, 11a, 6Ra, 6Ga, 6Ba, 6b, 10b: light; 6R: red color semiconductor laser; 6G: green color semiconductor laser; 6B: blue color semiconductor laser; 6c, 8c: illumination light; 60a, 60b, 60c: angular intensity distributions of light; 7, 9: light intensity distribution conversion elements; 7a, 9a: light incident surfaces; 7b, 9b: light emission surfaces; 70: light diffusion structure; 90: light diffusion structure; 70a, 70b, 70d, 70e: slants; 70c: cylindrical surface; 91: light guide unit; 92: optical path changing unit; 9c, 9d: main surfaces; 9e, 9h: reflection surfaces; 9g, 9f: surfaces; and 110, 120, 130, 140: liquid crystal display devices.

1-14. (canceled)

15. A light intensity distribution conversion element comprising:
a first light incident surface which first light having directivity enters; a first light emission surface, having a curved surface portion of a concave shape with respect to an emitting direction of the first light, that broadens an angular intensity distribution of the first light; and
a total reflection surface that is slanted against the emitting direction of the first light, and that totally reflects the first light,
wherein the first light reflected by the total reflection surface is emitted from the curved surface portion.

16. The light intensity distribution conversion element in claim 15, wherein
the curved surface portion forms a cylindrical lens; and
when a direction of a line, from among lines connecting two generating lines located at edges of a lens surface of the cylindrical lens of the curved surface portion, that is perpendicular to the two generating lines is assumed to be a first direction and a direction of the generating lines is assumed to be a second direction, the total reflection surface is a surface located at a side of a first direction edge of the curved surface portion.

17. The light intensity distribution conversion element in claim 16, wherein
the curved surface portion is disposed between two of the total reflection surfaces; and
a distance between the two total reflection surfaces increases as moving from an edge, of the total reflection surface, being close to the curved surface portion toward the other edge of the total reflection surface, and the other edge is disposed at an incident side of the first light with respect to the curved surface portion.

18. A planar light source device comprising:
the light intensity distribution conversion element in claim 16;
a first light source that emits the first light; and
a light guide plate that has a second light incident surface which the first light emitted from the light intensity distribution conversion element enters, and that has a second light emission surface where the first light which enters through the second light incident surface is emitted, wherein
the first light is emitted from the second light incident surface after being converted into planar light with the light guide plate;
a longitudinal direction of the second light incident surface is parallel to the second direction; and
the second light incident surface is disposed to face the first light emission surface.

19. A planar light source device comprising:
the light intensity distribution conversion element in claim 17;
a first light source that emits the first light; and
a light guide plate that has a second light incident surface which the first light emitted from the light intensity distribution conversion element enters, and that has a second light emission surface where the first light which enters through the second light incident surface is emitted, wherein
the first light is emitted from the second light incident surface after being converted into planar light with the light guide plate;
a longitudinal direction of the second light incident surface is parallel to the second direction; and
the second light incident surface is disposed to face the first light emission surface.

20. The planar light source device in claim 18, wherein
the first light emitted from the first light source has a direction that has a larger divergence angle and a direction that has a smaller divergence angle; and
the first light source is disposed so that the smaller divergence angle direction of the first light will be parallel to the first direction.

21. The planar light source device in claim 19, wherein
the first light emitted from the first light source has a direction that has a larger divergence angle and a direction that has a smaller divergence angle; and
the first light source is disposed so that the smaller divergence angle direction of the first light will be parallel to the first direction.

22. The planar light source device in claim 18, wherein
the first light incident surface has a light diffusion structure; and
the light diffusion structure diverges the first light in the second direction.

23. The planar light source device in claim 19, wherein
the first light incident surface has a light diffusion structure; and
the light diffusion structure diverges the first light in the second direction.

24. The planar light source device in claim 18, wherein
the first light source is disposed at the side of a rear surface which is a surface opposite to the second light emission surface of the light guide plate; and
the light intensity distribution conversion element has, on an optical path from the first light incident surface through the first light emission surface, a light guide unit and an optical path changing unit so as to guide the first light from the first light incident surface toward the second light incident surface.

25. The planar light source device in claim 19, wherein
the first light source is disposed at the side of a rear surface which is a surface opposite to the second light emission surface of the light guide plate; and
the light intensity distribution conversion element has, on an optical path from the first light incident surface through the first light emission surface, a light guide unit and an optical path changing unit so as to guide the first light from the first light incident surface toward the second light incident surface.

26. The planar light source device in claim 24, wherein the light guide unit has a plate-like shape, is disposed to face the rear surface, and has a wedge shape whose thickness increases from the first light incident surface toward a traveling direction of the first light.

27. The planar light source device in claim 24, further comprising
a second light source that has a wider divergence angle than a divergence angle of the first light when emitted from the first light source, wherein
the second light enters the light guide plate through the second light incident surface.

28. The planar light source device in claim 27, further comprising
a reflection member that reflects the second light, wherein
the second light source is disposed in a direction of the rear surface of the light guide plate with respect to the light guide plate; and
the second light, whose traveling direction is changed by the reflection member, enters the light guide plate through the second light incident surface.

29. The planar light source device in claim 28, wherein the reflection member has a reflection surface whose cross-sectional surface perpendicular to the second direction is a part of an ellipse having its paired focuses at a light emitting surface center of the second light source and at a center of the second light incident surface.

30. The planar light source device in claim 20, wherein the first light source has a laser element.

31. The planar light source device in claim 21, wherein the first light source has a laser element.

32. The planar light source device in claim 27, wherein the second light source has an LED element.

33. A liquid crystal display device including the planar light source device in claim 20.

34. A liquid crystal display device including the planar light source device in claim 21.
